(19) United States
(12) Patent Application Publication
(10) Pub. No.: US 2024/0225084 A9
(43) Pub. Date: Jul. 11, 2024

(54) A Component for an Article and Method of Manufacture

(71) Applicant: Nicoventures Trading Limited, London (GB)

(72) Inventors: Richard HEPWORTH, London (GB); John RICHARDSON, London (GB)

(21) Appl. No.: 18/569,796

(22) PCT Filed: Jun. 17, 2022
(86) PCT No.: PCT/GB2022/051548

§ 371 Date: Dec. 13, 2023

(30) Foreign Application Priority Data
Jun. 18, 2021 (GB) 2108813.3

(51) Int. Cl. A24C 5/01; A24D 1/20; A24F 40/20; A24F 40/465; H01F 7/02; H01F 7/08

(52) U.S. Cl. CPC A24C 5/01; A24D 1/20; A24F 40/20; A24F 40/465; H01F 7/02; H01F 7/08; H05B 6/105

(57) ABSTRACT

The present invention relates to an article (1) for use in a non-combustible aerosol provision system, an apparatus for manufacturing an article (1) for use in a non-combustible aerosol provision system, and a method of manufacturing an article (1) for use in a non-combustible aerosol provision system. The apparatus comprises: an aerosol-generating material receiving section (41); and at least one magnet (48) configured to position a ferrous susceptor element (25) in a first predetermined position relative to an aerosol-generating material (15) received in the aerosol-generating material receiving section (41). The at least one magnet has a first operative state in which it is operative to exert a moving force on a ferrous susceptor element, and a second operative state. The at least one magnet can be selectively moved between the first and second operative states. A method of inserting a ferrous susceptor element (25) in an aerosol-generating material (15) comprises: holding a ferrous susceptor element on a susceptor transporter (52) using magnetic force from at least one magnet (48); transporting an aerosol-generating material along a first path (43) on an aerosol-generating material transporter (42); transporting the ferrous susceptor element (25) along a second path (53) on the susceptor transporter (52); and selectively operating the at least one magnet (48) between first and second operative states. Another method of positioning the susceptor (25) within a rod (16) of aerosol-generating material is also disclosed.

### TECHNICAL FIELD OF THE INVENTION

The present invention relates to an article for use in a non-combustible aerosol provision system, an apparatus for manufacturing an article for use in a non-combustible aerosol provision system, and a method of manufacturing an article for use in a non-combustible aerosol provision system.

### BACKGROUND OF THE INVENTION

Certain delivery systems produce an aerosol during use, which is inhaled by a user. For example, tobacco heating devices heat an aerosol-generating material such as tobacco to form an aerosol by heating, but not burning, the material. Such delivery systems commonly include a heating device with a heating element, which, when heated, heats the aerosol-generating material to release an aerosol.

### SUMMARY OF THE INVENTION

In accordance with embodiments of the invention, in a first aspect there is provided an apparatus for positioning a ferrous susceptor relative to an aerosol-generating material, the apparatus comprising an aerosol-generating material receiving section configured to receive an aerosol-generating material; at least one magnet, wherein the at least one magnet is configured to position a ferrous susceptor element in a first predetermined position relative to an aerosol-generating material received in the aerosol-generating material receiving section; wherein the at least one magnet has a first operative state in which the at least one magnet is operative to exert a moving force on a ferrous susceptor element, and a second operative state; wherein the at least one magnet can be selectively moved between the first operative state and the second operative state.

In some embodiments, in the second operative state, the at least one magnet may be operative to exert a moving force on a ferrous susceptor element that is opposite to the moving force applied in the first operative state.

In some embodiments, in the second operative state that at least one magnet may be non-operative and unable to exert a moving force on a ferrous susceptor element.

In some embodiments, the aerosol-generating material receiving section may comprise an aerosol-generating material transporter configured to transport an aerosol-generating material along a first path.

In some embodiments, the apparatus may further comprise a susceptor transporter configured to transport a ferrous susceptor element along a second path.

In some embodiments, the at least one magnet may be configured to be selectively operated along the second path to insert a ferrous susceptor element into an aerosol-generating material transported along the first path at a predefined insertion point where the first and second paths overlap.

In some embodiments, the apparatus may further comprise an overlapping section of the first and second paths, the at least one magnet being selectively moved from one state to the other to insert a ferrous susceptor element into an aerosol-generating material.

In some embodiments, at the overlapping section of the first and second paths, the susceptor transporter may be located vertically above the aerosol-generating material transporter.

In some embodiments, the at least one magnet may be located above at least a portion of the susceptor transporter.

In some embodiments, the at least one magnet may be located above the overlapping portion of the second path of the susceptor transporter.

In some embodiments, the at least one magnet may be located above the predefined insertion point, and configured to be selectively moved from one state to the other to insert a ferrous susceptor element into an aerosol-generating material.

In some embodiments, the at least one magnet may be moveable along a path which overlaps the overlapping portion of the first and second paths.

In some embodiments, the at least one magnet may be selectively moved between the first operative state and the second operative state, when the at least one magnet is located above the predefined insertion point.

In some embodiments, the at least one magnet may be at least one electromagnet powered by a power source, the power source being configured to power the electromagnet in the first operative state and to switch the electromagnet into the second operative state at the predefined insertion point.

In some embodiments, the at least one magnet may be moveable in a direction away from the second path to move the at least one magnet from the first operative state to the second operative state, when the at least one magnet is located above the predefined insertion point.

In some embodiments, the at least one magnet may be stationary.

In some embodiments, the at least one magnet may comprise a downstream end which is located upstream of the predefined insertion point such that when a ferrous susceptor element passes the at least one magnet, the at least one magnet is in a second operative state in which it is unable to attract a ferrous susceptor element.

In some embodiments, the at least one magnet may comprise at least one electromagnet, the at least one electromagnet being selectively operated to be in a first operative state upstream of the predefined insertion point, and in a second operative state at the predefined insertion point.

In some embodiments, the apparatus may comprise a plurality of electromagnets configured to act as a linear induction motor.

In some embodiments, the plurality of electromagnets may form the susceptor transporter.

In some embodiments, the apparatus may further comprise at least one second magnet, the at least one second magnet being located below the aerosol-generating transporter, and being configured to be in the first operative state at the predefined insertion point to attract a ferrous susceptor element into an aerosol-generating material.

In some embodiments, the at least one second magnet may be located below the predefined insertion point.

In some embodiments, the at least one second magnet may be stronger than the at least one magnet.

In some embodiments, the susceptor transporter may be a conveyor belt. In some embodiments, the susceptor transporter may be a rotary wheel.

In some embodiments, the aerosol-generating material receiving section may comprise a susceptor positioning device comprising a rod receiving space configured to receive an aerosol-generating material rod comprising a ferrous susceptor element.

In some embodiments, the rod receiving section may be defined by a plurality of magnets.

In some embodiments, the plurality of magnets may be equally spaced around the aerosol-generating material receiving section.

In some embodiments, the plurality of magnets may be configured to create equal repulsive forces when in the first operative state to align a ferrous susceptor element with a central axis of plurality of magnets.

In some embodiments, the plurality of magnets may be configured such that the force exerted on a ferrous susceptor element by any one magnet may be varied in order to position a ferrous susceptor element in an aerosol-generating material.

In some embodiments, the force exerted by any one of the plurality of magnets on a ferrous susceptor may be varied by moving any one of the plurality of magnets.

In some embodiments, the plurality of magnets may comprise a plurality of electromagnets, and the force exerted by any one of the plurality of electromagnets may be varied by varying the power supplied to any one of the plurality of electromagnets.

In some embodiments, the apparatus may further comprise at least one second magnet, wherein the at least one second magnet is spaced longitudinally along the axis of the rod receiving space from the at least one magnet, the at least one first magnet and the at least one second magnet being configured to position a ferrous susceptor element in the longitudinal direction within an aerosol-generating material rod.

In some embodiments, the rod receiving space may be located on a first path of an aerosol-generating material through the apparatus.

In some embodiments, the rod receiving space may be an article receiving chamber of an inductive heating aerosol provision device.

In another aspect of the invention, there is provided a method of inserting a ferrous susceptor element in an aerosol-generating material, the method comprising holding a ferrous susceptor element on a susceptor transporter using magnetic force from at least one magnet; transporting an aerosol-generating material along a first path on an aerosol-generating material transporter; transporting the ferrous susceptor element along a second path on a susceptor transporter; and selectively operating the at least one magnet between a first operative state to exerts a moving force on the ferrous susceptor element, and a second operative state in which the at least one magnet is unable to exert a moving force on the ferrous susceptor element.

In some embodiments, the at least one magnet may be moved from the first operative state to the second operative state at the predefined insertion point to insert the ferrous susceptor element into the aerosol-generating material.

In some embodiments, the method may further comprise varying the magnetic force exerted on the ferrous susceptor element at a predefined insertion point where the second path overlaps the first path to cause the ferrous susceptor element to be placed at least on to the aerosol-generating material.

In some embodiments, the at least one magnet may be moved along at least a portion of the second path together with the susceptor transporter.

In some embodiments, the at least one magnet may be a permanent magnet, and wherein the at least one magnet is moved away from the second path at the predefined insertion point to at least reduce the magnetic force from the ferrous susceptor element, so that the ferrous susceptor element drops from the susceptor transporter at least onto the aerosol-generating material transporter.

In some embodiments, the at least one magnet may be an electromagnet, and wherein the power supplied to the electromagnet is reduced at the predefined insertion point to at least reduce the magnetic force from the ferrous susceptor element, so that the ferrous susceptor element drops from the susceptor transporter at least onto the aerosol-generating material on the aerosol-generating material transporter.

In some embodiments, the at least one magnet may be stationary above at least a portion of the second path, and the susceptor transporter is moved relative to the at least one magnet.

In some embodiments, the at least one magnet may be a permanent magnet having a downstream end located upstream of the predefined insertion point, and wherein the susceptor transporter transports the ferrous susceptor element downstream of and away from the permanent magnet such that the magnet is unable to exert sufficient force to retain the ferrous susceptor element on the susceptor transport so that the ferrous susceptor magnet is dropped at least onto the aerosol-generating material.

In some embodiments, the at least one magnet may comprise a plurality of electromagnets arranged linearly above the susceptor transporter along at least a portion of the second path, wherein the power supplied to the plurality of electro magnets is varied to cause the ferrous susceptor element to move along the second path to the predefined insertion point.

In some embodiments, the plurality of electromagnets may act as a linear electric induction motor which forms the susceptor transporter.

In some embodiments, the at least one magnet may be an at least one first magnet, and may further comprise providing at least one second magnet below the aerosol-generating material transporter at the predefined insertion point configured to apply a force on a susceptor to move the susceptor from the susceptor transporter to the aerosol-generating material on the aerosol-generating material transporter.

In some embodiments, the method may comprise applying a stronger magnetic force to the susceptor with the at least one second magnet than with the at least one first magnet.

In another aspect of the invention, there is provided a method of positioning a susceptor within a rod of aerosol-generating material; the method comprising: placing a rod of aerosol-generating material comprising a susceptor between at least two magnets; applying a magnetic field to the susceptor move the susceptor to a predefined position in the rod of aerosol-generating material using magnetic forces.

In some embodiments, the at least two magnets may be electromagnets, and moving the susceptor may comprise applying an electromagnetic filed to the susceptor to position it correctly relative to the rod of aerosol-generating material.

In another aspect of the invention, there is provided a method of manufacturing an aerosol-generating composition for use in a non-combustible aerosol provision device, the composition comprising aerosol-generating material and one or more magnetic elements, the method comprising: combining the aerosol-generating material with the one or more magnetic elements; applying a magnetic force to the one or more magnetic elements; and manipulating a position of the elements with respect to the aerosol-generating material using the applied magnetic force.

In some embodiments, the method may further comprise wrapping the aerosol-generating composition with a wrapper.

In another aspect of the invention, there is provided a method of separating one or more magnetic elements from aerosol-generating material, the method comprising: applying a magnetic force to the one or more magnetic elements to magnetically attract or repel the one or more elements such that the one or more elements become separated from the aerosol-generating material.

### BRIEF DESCRIPTION OF THE DRAWINGS

Embodiments of the invention will now be described, by way of example only, with reference to the accompanying drawings, in which:

FIG. 1 shows a side on cross-sectional view of an article;

FIG. 2 shows a side on cross-sectional view of an article;

FIG. 3 shows a side on cross-sectional view of a component of an article;

FIG. 4 shows an end view of a component of an article;

FIG. 5A shows a schematic view of a susceptor material;

FIG. 5B shows a schematic view of a susceptor material;

FIG. 5C shows a schematic view of a susceptor material;

FIG. 6 shows an apparatus for forming a component of an article;

FIG. 7 shows a part of an apparatus for forming a component of an article;

FIG. 8 shows a part of an apparatus for forming a component of an article;

FIG. 9 shows a part of an apparatus for forming a component of an article;

FIG. 10 shows a part of an apparatus for forming a component of an article;

FIG. 11 shows a part of an apparatus for forming a component of an article;

FIG. 12 shows a part of an apparatus for forming a component of an article;

FIG. 13 shows a part of an apparatus for forming a component of an article;

FIG. 14 shows a cross-sectional view of a non-combustible aerosol-provision device;

FIG. 15 shows a simplified schematic of the components within the housing of the aerosol provision device shown in FIG. 14; and

FIG. 16 shows a cross-sectional view of the non-combustible aerosol provision device shown in FIG. 14 with the article shown in FIG. 1 inserted into the device.

### DETAILED DESCRIPTION

The present invention relates to an article for consumable for use in a delivery system.

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokeable material); and
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo, and a cigar.

In some embodiments, the disclosure relates to a component for use in a combustible aerosol provision system, such as a filter, a filter rod, a filter segment, or an aerosol-modifying agent release component.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid, or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system may comprise an area for receiving the consumable, an aerosol generator, and aerosol generation area, a housing, a mouthpiece, a filter, and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, thiene, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”. The aerosol-generating material may comprise or be a “monolithic solid”. The aerosol-generating material may be, or comprise a component that is, fibrous or non-fibrous. In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

In some embodiments, the amorphous solid comprises: 1-60 wt % of a gelling agent; 0.1-50 wt % of an aerosol-former agent; and 0.1-80 wt % of a flavour; wherein these weights are calculated on a dry weight basis.

In some further embodiments, the amorphous solid comprises: 1-50 wt % of a gelling agent; 0.1-50 wt % of an aerosol-former agent; and 30-60 wt % of a flavour; wherein these weights are calculated on a dry weight basis.

In some further embodiments, the amorphous solid comprises: aerosol-former material in an amount of from about 40 to 80 wt % of the amorphous solid; gelling agent and optional filler (i.e. in some examples filler is present in the amorphous solid, in other examples filler is not present in the amorphous solid), wherein the amount of gelling agent and filler taken together is from about 10 to 60 wt % of the amorphous solid (i.e. the gelling agent and filler taken together account for about 10 to 60 wt % of the amorphous solid); and optionally, active substance and/or flavourant in an amount of up to about 20 wt % of the amorphous solid (i.e. the amorphous solid comprises ≤20 wt % active substance).

The amorphous solid material may be formed from a dried gel. It has been found that using the component proportions discussed above means that as the gel sets, flavour compounds are stabilised within the gel matrix allowing a higher flavour loading to be achieved than in non-gel compositions. The flavour (e.g. menthol) is stabilised at high concentrations and the products have a good shelf life.

In some cases, the amorphous solid may have a thickness of about 0.015 mm to about 1.5 mm. Suitably, the thickness may be in the range of about 0.05 mm, 0.1 mm or 0.15 mm to about 0.5 mm, 0.3 mm or 1 mm. A material having a thickness of 0.2 mm is particularly suitable in some embodiments. The amorphous solid may comprise more than one layer, and the thickness described herein refers to the aggregate thickness of those layers.

If the amorphous solid is too thick, then heating efficiency is compromised. This adversely affects the power consumption in use. Conversely, if the amorphous solid is too thin, it is difficult to manufacture and handle; a very thin material is harder to cast and may be fragile, compromising aerosol formation in use.

Suitably, the amorphous solid may comprise from about 1 wt %, 5 wt %, 10 wt %, 15 wt %, 20 wt %, 25 wt %, 30 wt % or 35 wt % to about 60 wt %, 55 wt %, 50 wt %, 45 wt %, 40 wt % or 35 wt % of a gelling agent (all calculated on a dry weight basis). For example, the amorphous solid may comprise 1-60 wt %, 5-60 wt %, 20-60 wt %, 25-55 wt %, 30-50 wt %, 35-45 wt %, 5-45 wt %, 10-40 wt % or 20-35 wt % of a gelling agent.

The amorphous solid may comprise a gelling agent. The gelling agent may comprise one or more compounds selected from cellulosic gelling agents, non-cellulosic gelling agents, guar gum, acacia gum and mixtures thereof.

In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, polydimethylsiloxane (PDMS), sodium silicate, kaolin and polyvinyl alcohol. In some cases, the gelling agent comprises alginate and/or pectin, and may be combined with a setting agent (such as a calcium source) during formation of the amorphous solid. In some cases, the amorphous solid may comprise a calcium-crosslinked alginate and/or a calcium-crosslinked pectin.

The cellulosic gelling agent can be selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In some embodiments, the amorphous solid comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

In some embodiments, the amorphous solid comprises filler in an amount of from 1 to 30 wt % of the amorphous solid, such as 5 to 25 wt %, or 10 to 20 wt %. In examples, the amorphous solid comprises filler in an amount greater than 1 wt %, 5 wt %, or 8 wt % of the amorphous solid. In examples, the amorphous solid comprises filler in an amount less than 40 wt %, 30 wt %, 20 wt %, 15 wt %, 12 wt % 10 wt %, 5 wt %, or 1 wt % of the amorphous solid. In other examples, the amorphous solid does not comprise filler.

In examples, the amorphous solid comprises gelling agent and filler, taken together, in an amount of from about 10 wt %, 20 wt %, 25 wt %, 30 wt %, 35 wt %, 40 wt %, 45 wt %, 50 wt %, 55 wt % or from about 60 wt %. In examples, the amount of gelling agent and filler, taken together, is no more than 85 wt %, 80 wt %, 75 wt %, 70 wt %, 65 wt %, or no more than 60 wt % of the amorphous solid. In examples, the amorphous solid comprises gelling agent and filler, taken together, in an amount of from about 20 to 60 wt %, 25 to 55 wt %, 30 to 50 wt %, or 35 to 45 wt % of the amorphous solid.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives. In particular cases, the amorphous solid comprises no calcium carbonate such as chalk.

In some examples which include filler, the filler may be fibrous. For example, the filler may be a fibrous organic filler material such as wood pulp, hemp fibre, cellulose or cellulose derivatives. Without wishing to be bound by theory, it is believed that including fibrous filler in an amorphous solid may increase the tensile strength of the material.

In some examples, the amorphous solid does not comprise tobacco fibres. In particular examples, the amorphous solid does not comprise fibrous material.

In some embodiments, the amorphous solid may comprise from about 0.1 wt %, 0.5 wt %, 1 wt %, 3 wt %, 5 wt %, 7 wt % or 10 wt % to about 80 wt %, 50 wt %, 45 wt %, 40 wt %, 35 wt %, 30 wt % or 25 wt % of an aerosol former material (all calculated on a dry weight basis). For example, the amorphous solid may comprise 0.5-40 wt %, 3-35 wt % or 10-25 wt % of an aerosol former material.

The aerosol former material may act as a plasticiser. If the content of the plasticiser is too high, the amorphous solid may absorb water resulting in a material that does not create an appropriate consumption experience in use. If the plasticiser content is too low, the amorphous solid may be brittle and easily broken.

In some embodiments, the aerosol former included in the amorphous solid comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some cases, the aerosol former material comprises one or more compound selected from erythritol, propylene glycol, glycerol, triacetin, sorbitol and xylitol. In some cases, the aerosol former material comprises, consists essentially of or consists of glycerol.

The amorphous solid material may comprise a combustion retarding salt. The combustion retarding salt used herein is a chemical compound consisting of an ionic assembly of cations and anions. The salts used herein are those whose anion and/or whose cation may be effective in retarding combustion. In some embodiments, the salt is an inorganic salt.

In some embodiments, the salt is a halide salt, i.e. has a halide anion. In some embodiments, the salt is a chloride salt or a bromide salt. The presence of high concentrations of chloride or bromide has been shown to retard combustion.

In some embodiments, the salt may be an alkali metal salt, i.e. has an alkali metal cation. In some embodiments, the salt has an alkali earth metal cation. In some embodiments, the salt has a zinc cation or an iron cation, such as ferric or ferrous cation. In some embodiments, the salt has an ammonium cation or phosphonium cation.

In some embodiments, the salt mat be an alkali metal halide, such as sodium chloride or potassium chloride. The salt may be an alkali earth metal halide, such as magnesium chloride, calcium chloride. The salt may be another metal halide, such as zinc chloride or sodium bromide.

In some embodiments, the salt has a carboxylate anion. For example, the salt may be an alkali metal carboxylate, such as potassium citrate, potassium succinate, potassium malate, potassium acetate, potassium tartrate, potassium oxalate, sodium citrate, sodium succinate, sodium acetate, or sodium malate.

In other embodiments, the salt has an anion selected from: borate, carbonate, phosphate, sulphate, or sulphamate.

Factors that may influence the selection of salt will include, for example, melting point, which will preferably be at least 450° C. In some embodiments, the salt is soluble in water. In some embodiments, the salt is selected to provide a desired pH to the material it is added to. In some embodiments, the salt will not significantly change the pH of the material.

In some embodiments, the combustion retarding salt selected may have one or more advantageous properties, such as: inertness, solubility in a precursor liquid, solubility, or distribution in the amorphous solid material or precursor material to the amorphous solid material, density or other properties known in the art.

In some embodiments, the combustion retarding slat comprises, consists essentially of, or consists of sodium chloride, potassium chloride, sodium bromide, and/or potassium bromide.

Depending on the combustion retarding or other physical properties desired, the components of the salt may be in free base form, salt form, or as a complex, or as a solvate. The combustion retarding salt may be of any density and any crystalline structure.

In some embodiments, the combustion retarding salt is incorporated into or added to the amorphous solid material dissolved in a solvent or liquid carrier. In some embodiments, the combustion retarding salt is suspended in a liquid carrier. The solvent or liquid carrier may be an aqueous or organic liquid, and may be polar or non-polar depending on it suitable application.

The liquid carrier or precursor solvent may be advantageously selected to be readily removed during the manufacture of the combustion retarding material to leave the combustion retarding slat in or on the amorphous solid material.

In some embodiments, the liquid carrier is a mixture of liquids, including aqueous liquid (water) and no-aqueous liquid (e.g. glycerol). Upon removal of the water following application of the salt, the glycerol will be retained in the amorphous solid material, where it offers flexibility and assists in aerosol formation upon heating.

The amorphous solid may comprise a colourant. The addition of a colourant may alter the visual appearance of the amorphous solid. The presence of colourant in the amorphous solid may enhance the visual appearance of the amorphous solid and the aerosol-generating material. By adding a colourant to the amorphous solid, the amorphous solid may be colour-matched to other components of the aerosol-generating material or to other components of an article comprising the amorphous solid.

A variety of colourants may be used depending on the desired colour of the amorphous solid. The colour of amorphous solid may be, for example, white, green, red, purple, blue, brown or black. Other colours are also envisaged. Natural or synthetic colourants, such as natural or synthetic dyes, food-grade colourants and pharmaceutical-grade colourants may be used. In certain embodiments, the colourant is caramel, which may confer the amorphous solid with a brown appearance. In such embodiments, the colour of the amorphous solid may be similar to the colour of other components (such as tobacco material) in an aerosol-generating material comprising the amorphous solid. In some embodiments, the addition of a colourant to the amorphous solid renders it visually indistinguishable from other components in the aerosol-generating material.

The colourant may be incorporated during the formation of the amorphous solid (e.g. when forming a slurry comprising the materials that form the amorphous solid) or it may be applied to the amorphous solid after its formation (e.g. by spraying it onto the amorphous solid).

The aerosol-generating material may comprise one or more active substances and/or flavours, one or more aerosol-former materials, and optionally one or more other functional material.

The aerosol-generating material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid is particularly preferred in embodiments in which the aerosol-generating material comprises nicotine. In such embodiments, the presence of an acid may stabilise dissolved species in the slurry from which the aerosol-generating material is formed. The presence of the acid may reduce or substantially prevent evaporation of nicotine during drying of the slurry, thereby reducing loss of nicotine during manufacturing.

In certain embodiments, the aerosol-generating material comprises a gelling agent comprising a cellulosic gelling agent and/or a non-cellulosic gelling agent, an active substance and an acid.

In some embodiments, the aerosol-generating material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol-generating material may comprise one or more cannabinoid compounds selected from the group consisting of cannabidiol (CBD) and THC (tetrahydrocannabinol).

The aerosol-generating material may comprise cannabidiol (CBD).

The aerosol-generating material may comprise nicotine and cannabidiol (CBD).

The aerosol-generating material may comprise nicotine, cannabidiol (CBD), and THC (tetrahydrocannabinol).

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. In some embodiments, the aerosol former comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

The one or more other functional materials may comprise one or more of pH regulators, colouring agents, preservatives, binders, fillers, stabilizers, and/or antioxidants.

As used herein, the term “tobacco material” refers to any material comprising tobacco or derivatives or substitutes thereof. The term “tobacco material” may include one or more of tobacco, tobacco derivatives, expanded tobacco, reconstituted tobacco or tobacco substitutes. The tobacco material may comprise one or more of ground tobacco, tobacco fibre, cut tobacco, extruded tobacco, tobacco stem, tobacco lamina, reconstituted tobacco and/or tobacco extract.

The tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent.

The tobacco material may contain an aerosol-former material. In some embodiments, the aerosol-former material of the tobacco material may be glycerol, propylene glycol, or a mixture of glycerol and propylene glycol. Glycerol may be present in an amount of from 10 to 20% by weight of the tobacco material, for example 13 to 16% by weight of the composition, or about 14% or 15% by weight of the composition. Propylene glycol, if present, may be present in an amount of from 0.1 to 0.3% by weight of the composition.

The aerosol-former material may be included in any component, for example any tobacco component, of the tobacco material, and/or in the filler component, if present. Alternatively or additionally the aerosol-former material may be added to the tobacco material separately. In either case, the total amount of the aerosol-former material in the tobacco material can be as defined herein.

In one example, the aerosol-former material may comprise an amorphous solid material comprising 40% menthol, 16% glycerol, 20% binder (alginate/pectin mix), and 20% fibres (wood pulp).

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor. The consumable may be any shape or size that is appropriate to the smoking device. In a preferred embodiment of the invention, the consumable is a rod shape.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Articles, for instance those in the shape of rods, are often named according to the product length: “regular” (typically in the range 68-75 mm, e.g. from about 68 mm to about 72 mm), “short” or “mini” (68 mm or less), “king-size” (typically in the range 75-91 mm, e.g. from about 79 mm to about 88 mm), “long” or “super-king” (typically in the range 91-105 mm, e.g. from about 94 mm to about 101 mm) and “ultra-long” (typically in the range from about no mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm).

Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol generating material and will usually have a greater length than the mouthpiece, for example from 3 to 10 mm longer, such that the tipping paper covers the mouthpiece and overlaps the aerosol generating material, for instance in the form of a rod of material, to connect the mouthpiece to the rod.

Articles and their aerosol generating materials and mouthpieces described herein can be made in, but are not limited to, any of the above formats.

The filamentary tow or filter material described herein can comprise cellulose acetate fibre tow. The filamentary tow can also be formed using other materials used to form fibres, such as polyvinyl alcohol (PVOH), polylactic acid (PLA), polycaprolactone (PCL), poly(1-4 butanediol succinate) (PBS), poly(butylene adipate-co-terephthalate) (PBAT), starch based materials, cotton, aliphatic polyester materials and polysaccharide polymers or a combination thereof. The filamentary tow may be plasticised with a suitable plasticiser for the tow, such as triacetin where the material is cellulose acetate tow, or the tow may be non-plasticised. The tow can have any suitable specification, such as fibres having a cross section which is ‘Y’ shaped, ‘X’ shaped or ‘O’ shaped. The fibres of the tow may have filamentary denier values between 2.5 and 15 denier per filament, for example between 8.0 and 11.0 denier per filament and total denier values of 5,000 to 50,000, for example between 10,000 and 40,000. The cross section of the fibres may have an isoperimetric ratio L²/A of 25 or less, preferably 20 or less, and more preferably 15 or less, where L is the length of the perimeter of the cross section and A is the area of the cross section. Such fibres have a relatively low surface area for a given value of denier per filament, which improves delivery of aerosol to the consumer. Filter material described herein also includes cellulose-based materials such as paper. Such materials may have a relatively low density, such as between about 0.1 and about 0.45 grams per cubic centimetre, to allow air and/or aerosol to pass through the material. Although described as filter materials, such materials may have a primary purpose, such as increasing the resistance to draw of a component, that is not related to filtration as such.

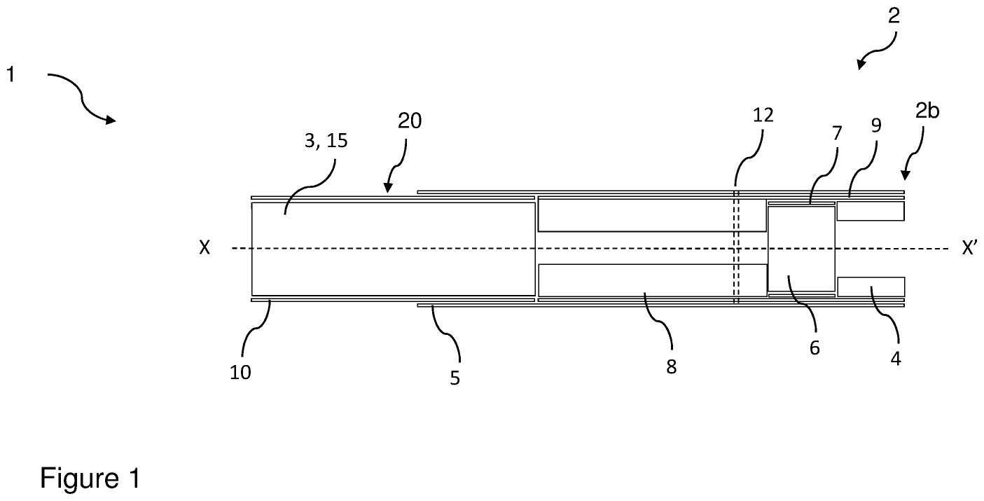

FIG. 1 is a side-on cross-sectional view of an article for use in an aerosol delivery system.

The article 1 comprises a mouthpiece 2, and an aerosol-generating section, connected to the mouthpiece 2. In the present example, the aerosol-generating section comprises a source of aerosol-generating material in the form of a cylindrical rod of aerosol-generating material 3. The aerosol-generating section may be formed form an aerosol-generating substrate 15. The aerosol-generating substrate 15 may be the source of aerosol-generating material. In other examples, the aerosol-generating section may comprise a cavity for receiving a source of aerosol-generating material. The aerosol-generating material may comprise a plurality of strands or strips of aerosol-generating material. For example, the aerosol-generating material may comprise a plurality of strands or strips of an aerosolisable material and/or a plurality of strands or strips of an amorphous solid material, as described hereinbelow. In some embodiments, the aerosol-generating material consists of a plurality of strands or strips of aerosolisable material.

The aerosol-generating section may comprise a single type of aerosol-generating material. In other embodiments, the aerosol-generating section may comprise multiple types of aerosol=generating material, for example, but not limited to, reconstituted tobacco and an amorphous solid.

In the present example, the cylindrical rod of aerosol-generating material 3 comprise a plurality of strands and/or strips of aerosol-generating material, and is circumscribed by a wrapper 10. In the present example, the wrapper 10 is a moisture impermeable wrapper. That is, an aerosol-generating materials section 20 or rod 20 is formed when the aerosol-generating material 3 is wrapped in a wrapper 10.

The plurality of strands or strips of aerosol-generating material may be aligned within the aerosol-generating section such that their longitudinal dimension is in parallel alignment with the longitudinal axis, X-X′ of the article 1. Alternatively, the strands or strips may generally be arranged such that their longitudinal dimension aligned is transverse to the longitudinal axis of the article.

At least about 10%, 20%, 30%, 40%, 50%, 60%, 70%, 80%, 90% or 95% of the plurality of strands or strips may be arranged such that their longitudinal dimension is in parallel alignment with the longitudinal axis of the article. A majority of the strands or strips may be arranged such that their longitudinal dimensions are in parallel alignment with the longitudinal axis of the article. In some embodiments, about 95% to about 100% of the plurality of strands or strips are arranged such that their longitudinal dimension is in parallel alignment with the longitudinal axis of the article. In some embodiments, substantially all of the strands or strips are arranged in the aerosol-generating section such that their longitudinal dimension is in parallel alignment with the longitudinal axis of the aerosol-generating section of the article.

Where the majority of the strands or strips are arranged in the aerosol-generating section such that their longitudinal axis is parallel with the longitudinal axis of the aerosol-generating section of the article, the force required to insert an aerosol generator into the aerosol-generating material can be relatively low. This can result in an article which is easier to use.

In the present example, the rod of aerosol-generating material 3 has a circumference of about 22.7 mm. In alternative embodiments, the rod of aerosol-generating material 3 may have any suitable circumference, for example between about 20 mm and about 26 mm.

The article 1 is configured for use in a non-combustible aerosol provision device comprising an aerosol generator for insertion into the aerosol generating section. In the present example, the aerosol generator is a heater, and the article is configured to receive the aerosol generator in the rod of aerosol-generating material.

The mouthpiece 2 may include a cooling section 8, as illustrated, also referred to as a cooling element, positioned immediately downstream of and adjacent to the source of aerosol-generating material 3. In the present example, the cooling section 8 is in an abutting relationship with the source of aerosol-generating material. The mouthpiece 2 also includes, in the present example, a body of material 6 downstream of the cooling section 8, and a hollow tubular element 4 downstream of the body of material 6, at the mouth end of the article 1.

The cooling section 8 may comprises at least one hollow channel. The hollow channel may have an internal diameter of between about 1 mm and about 4 mm, for example between about 2 mm and about 4 mm. In the present example, the hollow channel has an internal diameter of about 3 mm. The hollow channel extends along the full length of the cooling section 8. In the present example, the single hollow channel is substantially cylindrical, although in alternative embodiments, other channel geometries/cross-sections may be used. The hollow channel can provide a space into which aerosol drawn into the cooling section 8 can expand and cool down. In all embodiments, the cooling section is configured to limit the cross-sectional area of the hollow channel/s, to limit tobacco displacement into the cooling section, in use.

The moisture impermeable wrapper 10 can have a lower friction with the aerosol-generating material, which can result in strands and/or strips of aerosol-generating material being more easily displaced longitudinally, into the cooling section, when the aerosol generator is inserted into the rod of aerosol-generating material. Providing a cooling section 8 directly adjacent to the source of aerosol generating material, and comprising an inner channel with a diameter in this range, advantageously reduces the longitudinal displacement of strands and/or strips of aerosol-generating material when the aerosol generator is inserted into the rod of aerosol-generating material. Reducing the displacement of aerosol-generating material, in use, can advantageously result in a more consistent packing density of aerosol-generating material along the length of the rod and/or within a cavity, which can result in more consistent and improved aerosol generation.

The cooling section 8 may be formed from a plurality of layers of paper which are parallel wound, with butted seams, to form the cooling section 8; or spirally wound layers of paper, cardboard tubes, tubes formed using a papier-mâchè type process, moulded or extruded plastic tubes or similar. The cooling section 8 is manufactured to have a rigidity that is sufficient to withstand the axial compressive forces and bending moments that might arise during manufacture and whilst the article 1 is in use.

The wall material of the cooling section 8 can be relatively non-porous, such that at least 90% of the aerosol generated by the aerosol generating material 3 passes longitudinally through the one or more hollow channels rather than through the wall material of the cooling section 8. For instance, at least 92% or at least 95% of the aerosol generated by the aerosol generating material 3 can pass longitudinally through the one or more hollow channels.

The mouthpiece 2 may comprise a cavity having an internal volume greater than 110 mm³. Providing a cavity of at least this volume has been found to enable the formation of an improved aerosol. More preferably, the mouthpiece 2 comprises a cavity, for instance formed within the cooling section 8, having an internal volume greater than 110 mm³, and still more preferably greater than 130 mm³, allowing further improvement of the aerosol. In some examples, the internal cavity comprises a volume of between about 130 mm³ and about 230 mm³, for instance about 134 mm³ or 227 mm³.

When in use, the aerosol-generating section may exhibit a pressure drop of from about 15 to about 40 mm H₂O. In some embodiments, the aerosol-generating section exhibits a pressure drop across the aerosol-generating section of from about 15 to about 30 mm H₂O.

The aerosol-generating material may have a packing density of between about 400 mg/cm³ and about 900 mg/cm³ within the aerosol-generating section. A packing density higher than this may make it difficult to insert the aerosol-generator of the aerosol provision device into the aerosol-generating material and increase the pressure drop. A packing density lower than 400 mg/cm³ may reduce the rigidity of the article. Furthermore, if the packing density is too low, the aerosol-generating material may not effectively grip the aerosol-generator of the aerosol provision.

At least about 70% of a volume of the aerosol-generating section is filled with the aerosol-generating material. In some embodiments, from about 75% to about 85% of the volume of the cavity is filled with the aerosol-generating material.

In the present embodiment, the moisture impermeable wrapper 10 which circumscribes the rod of aerosol-generating material comprises aluminium foil. In other embodiments, the wrapper 10 comprises a paper wrapper, optionally comprising a barrier coating to make the material of the wrapper substantially moisture impermeable. Aluminium foil has been found to be particularly effective at enhancing the formation of aerosol within the aerosol-generating material 3. In the present example, the aluminium foil has a metal layer having a thickness of about 6 μm. In the present example, the aluminium foil has a paper backing.

However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used.

The total thickness of the wrapper is preferably between 20 m and 60 μm, more preferably between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force. Where the wrapper comprises paper or a paper backing, i.e. a cellulose based material, the wrapper can have a basis weight greater than about 30 gsm. For example, the wrapper can have a basis weight in the range from about 40 gsm to about 70 gsm.

Such basis weights provide an improved rigidity to the rod of aerosol-generating material. The improved rigidity provided by wrappers having a basis weight in this range can make the rod of aerosol-generating material 3 more resistant to crumpling or other deformation under the forces to which the article is subject, in use, for example when the article is inserted into a device and/or a heat generator is inserted into the article. Providing a rod of aerosol-generating material having increased rigidity can be beneficial where the plurality of strands or strips of aerosol-generating material are aligned within the aerosol-generating section such that their longitudinal dimension is in parallel alignment with the longitudinal axis, since longitudinally aligned strands or strips of aerosol-generating material may provide less rigidity to the rod of aerosol generating material than when the strands or strips are not aligned. The improved rigidity of the rod of aerosol-generating material allows the article to withstand the increased forces to which the article is subject, in use.

In the present example, the moisture impermeable wrapper 10 is also substantially impermeable to air. In alternative embodiments, the wrapper 10 preferably has a permeability of less than 100 Coresta Units, more preferably less than 60 Coresta Units.

It has been found that low permeability wrappers, for instance having a permeability of less than 100 Coresta Units, more preferably less than 60 Coresta Units, result in an improvement in the aerosol formation in the aerosol-generating material 3. Without wishing to be bound by theory, it is hypothesised that this is due to reduced loss of aerosol compounds through the wrapper 10. The permeability of the wrapper 10 can be measured in accordance with ISO 2965:2009 concerning the determination of air permeability for materials used as cigarette papers, filter plug wrap and filter joining paper.

The body of material 6 and hollow tubular element 4 each define a substantially cylindrical overall outer shape and share a common longitudinal axis. The body of material 6 is wrapped in a first plug wrap 7. Preferably, the first plug wrap 7 has a basis weight of less than 50 gsm, more preferably between about 20 gsm and 40 gsm. Preferably, the first plug wrap 7 has a thickness of between 30 μm and 60 μm, more preferably between 35 μm and 45 μm. Preferably, the first plug wrap 7 is a non-porous plug wrap, for instance having a permeability of less than 100 Coresta units, for instance less than 50 Coresta units. However, in other embodiments, the first plug wrap 7 can be a porous plug wrap, for instance having a permeability of greater than 200 Coresta Units.

Preferably, the length of the body of material 6 is less than about 15 mm. More preferably, the length of the body of material 6 is less than about 12 mm. In addition, or as an alternative, the length of the body of material 6 is at least about 5 mm. Preferably, the length of the body of material 6 is at least about 8 mm. In some preferred embodiments, the length of the body of material 6 is from about 5 mm to about 15 mm, more preferably from about 6 mm to about 12 mm, even more preferably from about 6 mm to about 12 mm, most preferably about 6 mm, 7 mm, 8 mm, 9 mm or 10 mm. In the present example, the length of the body of material 6 is 10 mm.

In the present example, the body of material 6 is formed from filamentary tow. In the present example, the tow comprises plasticised cellulose acetate tow. In other examples, different materials can be used to form the body of material 6. For instance, rather than tow, the body 6 can be formed from paper, for instance in a similar way to paper filters known for use in cigarettes. For instance, the paper, or other cellulose-based material, can be provided as one or more portions of sheet material which is folded and/or crimped to form body 6.

Alternatively, the body 6 can be formed from tows other than cellulose acetate, for instance polylactic acid (PLA), other materials described herein for filamentary tow or similar materials. The tow is preferably formed from cellulose acetate. The tow, whether formed from cellulose acetate or other materials, preferably has a d.p.f. of at least 5. Preferably, to achieve a sufficiently uniform body of material 6, the tow has a denier per filament of no more than 12 d.p.f., preferably no more than 11 d.p.f. and still more preferably no more than 10 d.p.f.

Irrespective of the material used to form the body 6, the pressure drop across body 6, can, for instance, be between 0.3 and 5 mmWG per mm of length of the body 6, for instance between 0.5 mmWG and 2 mmWG per mm of length of the body 6. The pressure drop can, for instance, be between 0.5 and 1 mmWG/mm of length, between 1 and 1.5 mmWG/mm of length or between 1.5 and 2 mmWG/mm of length. The total pressure drop across body 6 can, for instance, be between 3 mmWG and 8 mWG, or between 4 mmWG and 7 mmWG. The total pressure drop across body 6 can be about 5, 6 or 7 mmWG.

As shown in FIG. 1, the mouthpiece 2 of the article 1 comprises an upstream end 2a adjacent to the rod of aerosol-generating material 3 and a downstream end 2b distal from the rod of aerosol-generating material 3. At the downstream end 2b, the mouthpiece 2 has a hollow tubular element 4 formed from filamentary tow. This has advantageously been found to significantly reduce the temperature of the outer surface of the mouthpiece 2 at the downstream end 2b of the mouthpiece which comes into contact with a consumer's mouth when the article 1 is in use. In addition, the use of the tubular element 4 has also been found to significantly reduce the temperature of the outer surface of the mouthpiece 2 even upstream of the tubular element 4. Without wishing to be bound by theory, it is hypothesised that this is due to the tubular element 4 channeling aerosol closer to the centre of the mouthpiece 2, and therefore reducing the transfer of heat from the aerosol to the outer surface of the mouthpiece 2.

Preferably, the length of the hollow tubular element 4 is less than about 20 mm. More preferably, the length of the hollow tubular element 4 is less than about 15 mm. Still more preferably, the length of the hollow tubular element 4 is less than about 10 mm. In addition, or as an alternative, the length of the hollow tubular element 4 is at least about 5 mm. Preferably, the length of the hollow tubular element 4 is at least about 6 mm. In some preferred embodiments, the length of the hollow tubular element 4 is from about 5 mm to about 20 mm, more preferably from about 6 mm to about 10 mm, even more preferably from about 6 mm to about 8 mm, most preferably about 6 mm, 7 mm or about 8 mm. In the present example, the length of the hollow tubular element 4 is 7 mm.

In the present example, the first hollow tubular element 4, body of material 6 and cooling section 8 are combined using a second plug wrap 9 which is wrapped around all three sections. Preferably, the second plug wrap 9 has a basis weight of less than 50 gsm, more preferably between about 20 gsm and 45 gsm. Preferably, the second plug wrap 9 has a thickness of between 30 μm and 60 μm, more preferably between 35 μm and 45 μm. The second plug wrap 9 is preferably a non-porous plug wrap having a permeability of less than 100 Coresta Units, for instance less than 50 Coresta Units. However, in alternative embodiments, the second plug wrap 9 can be a porous plug wrap, for instance having a permeability of greater than 200 Coresta Units.

In the present example, the article 1 has an outer circumference of about 23 mm. In other examples, the article can be provided in any of the formats described herein, for instance having an outer circumference of between 20 mm and 26 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 20 mm and 24 mm, and more preferably between 20 mm and 23 mm, have been found to provide a good balance between providing effective aerosol delivery while allowing for efficient heating.

A tipping paper 5 is wrapped around the full length of the mouthpiece 2 and over part of the rod of aerosol-generating material 3 and has an adhesive on its inner surface to connect the mouthpiece 2 and rod 3. In the present example, the rod of aerosol-generating material 3 is wrapped in wrapper 10, which forms a first wrapping material, and the tipping paper 5 forms an outer wrapping material which extends at least partially over the rod of aerosol-generating material 3 to connect the mouthpiece 2 and rod 3. In some examples, the tipping paper can extend only partially over the rod of aerosol-generating material.

In the present example, the tipping paper 5 extends 5 mm over the rod of aerosol-generating material 3 but it can alternatively extend between 3 mm and 10 mm over the rod 3, or more preferably between 4 mm and 6 mm, to provide a secure attachment between the mouthpiece 2 and rod 3. The tipping paper can have a basis weight greater than 20 gsm, for instance greater than 25 gsm, or preferably greater than 30 gsm, for example 37 gsm. These ranges of basis weights have been found to result in tipping papers having acceptable tensile strength while being flexible enough to wrap around the article 1 and adhere to itself along a longitudinal lap seam on the paper. The outer circumference of the tipping paper 5, once wrapped around the mouthpiece 2, is about 23 mm.

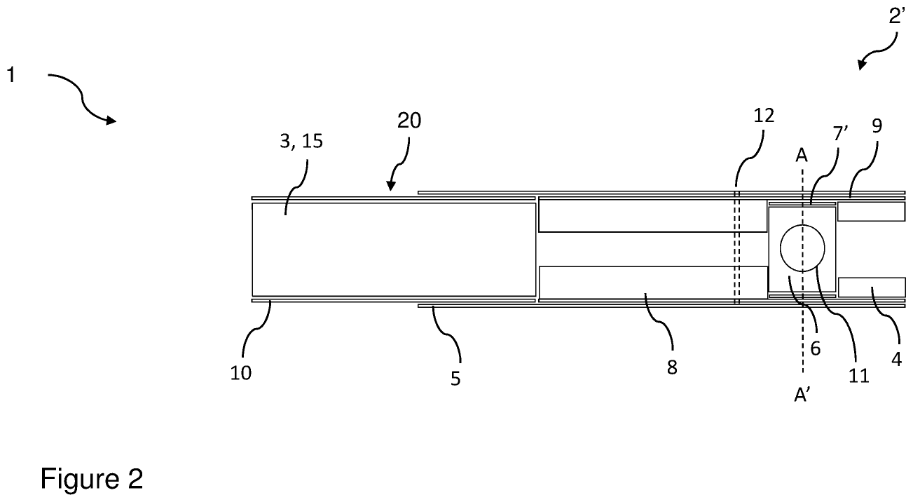

FIG. 2 is a side-on cross sectional view of a further article 1′ including a capsule-containing mouthpiece 2′. Article 1′ and capsule-containing mouthpiece 2′ are the same as the article 1 and mouthpiece 2 illustrated in FIG. 1, except that an aerosol modifying agent is provided within the body of material 6, in the present example in the form of a capsule 11, and that an oil-resistant first plug wrap 7′ surrounds the body of material 6. In other examples, the aerosol modifying agent can be provided in other forms, such as material injected into the body of material 6 or provided on a thread, for instance the thread carrying a flavourant or other aerosol modifying agent, which may also be disposed within the body of material 6.

The capsule 11 can comprise a breakable capsule, for instance a capsule which has a solid, frangible shell surrounding a liquid payload. In the present example, a single capsule 11 is used. The capsule 11 is entirely embedded within the body of material 6. In other words, the capsule 11 is completely surrounded by the material forming the body 6. In other examples, a plurality of breakable capsules may be disposed within the body of material 6, for instance 2, 3 or more breakable capsules. The length of the body of material 6 can be increased to accommodate the number of capsules required. In examples where a plurality of capsules is used, the individual capsules may be the same as each other, or may differ from one another in terms of size and/or capsule payload. In other examples, multiple bodies of material 6 may be provided, with each body containing one or more capsules.

The capsule 11 has a core-shell structure. In other words, the capsule 11 comprises a shell encapsulating a liquid agent, for instance a flavourant or other agent, which can be any one of the flavourants or aerosol modifying agents described herein. The shell of the capsule can be ruptured by a user to release the flavourant or other agent into the body of material 6. The first plug wrap 7′ can comprise a barrier coating to make the material of the plug wrap substantially impermeable to the liquid payload of the capsule 11. Alternatively or in addition, the second plug wrap 9 and/or tipping paper 5 can comprise a barrier coating to make the material of that plug wrap and/or tipping paper substantially impermeable to the liquid payload of the capsule 11.

In the present example, the capsule 11 is spherical and has a diameter of about 3 mm. In other examples, other shapes and sizes of capsule can be used. For example, the capsule may have a diameter less than 4 mm, or less than 3.5 mm, or less than 3.25 mm. In alternative embodiments, the capsule may have a diameter greater than about 3.25 mm, for example greater than 3.5 mm, or greater than 4 mm. The total weight of the capsule 11 may be in the range about 10 mg to about 50 mg.

In the present example, the capsule 11 is located at a longitudinally central position within the body of material 6. That is, the capsule 11 is positioned so that its centre is 5 mm from each end of the body of material 6. In the present example, the centre of the capsule is positioned 36 mm from the upstream end of the article 1. Preferably, the capsule is positioned so that its centre is positioned between 28 mm and 38 mm from the upstream end of the article 1, more preferably between 34 mm and 38 mm from the upstream end of the article 1. In the present example, the centre of the capsule is positioned 12 mm from the downstream end of the mouthpiece 2b. Providing a capsule at this position results in improved volatilisation of the capsule contents, due to the proximity of the capsule to the aerosol-generating section of the article which is heated in use, whilst also being far enough from the aerosol-generating section which, in use, is inserted into an aerosol provision system, to enable the user to readily access the capsule and burst it with their fingers.

In other examples, the capsule 11 can be located at a position other than a longitudinally central position in the body of material 6, i.e. closer to the downstream end of the body of material 6 than the upstream end, or closer to the upstream end of the body of material 6 than the downstream end.

The aerosol-generating material comprises a sheet or a shredded sheet of aerosolisable material. The aerosolisable material is arranged to generate aerosol when heated.

The sheet or shredded sheet comprises a first surface and a second surface opposite the first surface. The dimensions of the first and second surfaces are congruent. The first and second surfaces of the sheet or shredded sheet may have any shape. For example, the first and second surfaces may be square, rectangular, oblong or circular. Irregular shapes are also envisaged.

The first and/or second surfaces of the sheet or shredded sheet may be relatively uniform (e.g. they may be relatively smooth) or they may be uneven or irregular. For example, the first and/or second surfaces of the sheet may be textured or patterned to define a relatively coarse surface. In some embodiments, the first and/or second surfaces are relatively rough.

The smoothness of the first and second surfaces may be influenced by a number of factors, such as the area density of the sheet or shredded sheet, the nature of the components that make up the aerosolisable material or whether the surfaces of the material have been manipulated, for example embossed, scored or otherwise altered to confer them with a pattern or texture.

The areas of the first and second surfaces are each defined by a first dimension (e.g. a width) and a second dimension (e.g. a length). The measurements of the first and second dimensions may have a ratio of 1:1 or greater than 1:1 and thus the sheet or shredded sheet may have an “aspect ratio” of 1:1 or greater than 1:1. As used herein, the term “aspect ratio” is the ratio of a measurement of a first dimension of the first or second surface to a measurement of a second dimension of the first or second surface. An “aspect ratio of 1:1” means that a measurement of the first dimension (e.g. width) and a measurement of the second dimension (e.g. length) are identical. An “aspect ratio of greater than 1:1” a measurement of the first dimension (e.g. width) and a measurement of the second dimension (e.g. length) are different. In some embodiments, the first and second surfaces of the sheet or shredded sheet have an aspect ratio of greater than 1:1, such as 1:2, 1:3, 1:4, 1:5, 1:6, 1:7 or more.

The shredded sheet may comprise one or more strands or strips of the aerosolisable material. In some embodiments, the shredded sheet comprises a plurality (e.g. two or more) strands or strips of the aerosolisable material. The strands or strips of aerosolisable material may have an aspect ratio of 1:1. In an embodiment, the strands or strips of aerosolisable material have an aspect ratio of greater than 1:1. In some embodiments, the strands or strips of aerosolisable material have an aspect ratio of from about 1:5 to about 1:16, or about 1:5, 1:6, 1:7, 1:8, 1:9, 1:10, 1:11 or 1:12. Where the aspect ratio of the strands or strips is greater than 1:1, the strands or strips comprises a longitudinal dimension, or length, extending between a first end of the strand or strip and a second end of the strand or strip.

Where the shredded sheet comprises a plurality of strands or strips of material, the dimensions of each strand or strip may vary between different strands or strips. For example, the shredded sheet may comprise a first population of strands or strips and a second population of strands or strips, wherein the dimensions of the strands or strips of the first population are different to the dimensions of the strands or strips of the second population. In other words, the plurality of strands or strips may comprise a first population of strands or strips having a first aspect ratio and a second population of strands or strips having a second aspect ratio that is different to the first aspect ratio.

A first dimension, or cut width, of the strands or strips of aerosolisable material is between 0.9 mm and 1.5 mm. The inventors have found that, when strands or strips of aerosolisable material having a cut width of below 0.9 mm are incorporated into an article for use in a non-combustible aerosol provision system, the pressure drop across the article may be increased to a level that renders the article unsuitable for use in a non-combustible aerosol-provision device. However, if the strands or strips have a cut width above 2 mm (e.g. greater than 2 mm), then it may be challenging to insert the strands or strips of aerosolisable material into the article during its manufacture. In a preferred embodiment, the cut width of the strands or strips of aerosolisable material is between about 1 mm and 1.5 mm.

The strips of material are formed by shredding the sheet of aerosolisable material. The sheet of aerosolisable material may be cut width-wise, for example in a cross-cut type shredding process, to define a cut length for the strands or strips of aerosolisable material, in addition to a cut width. The cut length of the shredded aerosolisable material is preferably at least 5 mm, for instance at least 10 mm, or at least 20 mm. The cut length of the shredded aerosolisable material can be less than 60 mm, less than 50 mm, or less than 40 mm.

In some embodiments, a plurality of strands or strips of aerosolisable material is provided and at least one of the plurality of strands or strips of aerosolisable material has a length greater than about 10 mm. At least one of the plurality of strands or strips of aerosolisable material can alternatively or in addition have a length between about 10 mm and about 60 mm, or between about 20 mm and about 50 mm. Each of the plurality of strands or strips of aerosolisable material can have a length between about 10 mm and about 60 mm, or between about 20 mm and about 50 mm.

The sheet or shredded sheet of aerosolisable material has a thickness of at least about 100 μm. The sheet or the shredded sheet may have a thickness of at least about 120 μm, 140 μm, 160 μm, 180 μm or 200 μm. In some embodiments, the sheet or shredded sheet has a thickness of from about 150 μm to about 300 μm, from about 151 μm to about 299 μm, from about 152 μm to about 298 μm, from about 153 μm to about 297 μm, from about 154 μm to about 296 μm, from about 155 μm to about 295 μm, from about 156 μm to about 294 μm, from about 157 μm to about 293 μm, from about 158 μm to about 292 μm, from about 159 μm to about 291 μm or from about 160 μm to about 290 μm. In some embodiments, the sheet or shredded sheet has a thickness of from about 170 μm to about 280 μm, from about 180 to about 270 μm, from about 190 to about 260 μm, from about 200 μm to about 250 μm or from about 210 μm to about 240 μm.

The thickness of the sheet or shredded sheet may vary between the first and second surfaces. In some embodiments, an individual strip or piece of the aerosolisable material has a minimum thickness over its area of about 100 μm. In some cases, an individual strip or piece of the aerosolisable material has a minimum thickness over its area of about 0.05 mm or about 0.1 mm. In some cases, an individual strip, strand or piece of the aerosolisable material has a maximum thickness over its area of about 1.0 mm. In some cases, an individual strip or piece of the aerosolisable material has a maximum thickness over its area of about 0.5 mm or about 0.3 mm.

The thickness of the sheet can be determined using ISO 534:2011 “Paper and Board-Determination of Thickness”.

If the sheet or shredded sheet of aerosolisable material is too thick, then heating efficiency can be compromised. This can adversely affect power consumption in use, for instance the power consumption for release of flavour from the aerosolisable material. Conversely, if the aerosolisable material is too thin, it can be difficult to manufacture and handle; a very thin material can be harder to cast and may be fragile, compromising aerosol formation in use.

It is postulated that if the sheet or shredded sheet of aerosolisable material is too thin (e.g. less than 100 μm), then it may be necessary to increase the cut width of the shredded sheet to achieve sufficient packing of the aerosolisable material when it is incorporated into the article. As discussed previously, increasing the cut width of the shredded sheet can increase the pressure drop, which is undesirable.

It has postulated that a sheet or shredded sheet having a thickness of at least about 100 μm, along with an area density of from about 100 g/m² to about 250 g/m² is less liable to tear, split or become otherwise deformed during its manufacture. A thickness of at least about 100 μm may have a positive effect on the overall structural integrity and strength of sheet or shredded sheet. For example, it may have a good tensile strength and thus be relatively easy to process.

The thickness of the sheet or shredded sheet is also thought to have a bearing on its area density. That is to say, increasing the thickness of the sheet or shredded sheet may increase the area density of the sheet or shredded sheet.

Conversely, decreasing the thickness of the sheet or shredded sheet may decrease the area density of the sheet or shredded sheet. For the avoidance of doubt, where reference is made herein to area density, this refers to an average area density calculated for a given strip, strand, piece or sheet of the aerosolisable material, the area density calculated by measuring the surface area and weight of the given strip, strand, piece or sheet of aerosolisable material.

The sheet or shredded sheet of aerosol-generating material has an area density of from about 100 g/m² to about 250 g/m². The sheet or shredded sheet may have an area density of from about 110 g/m² to about 240 g/m², from about 120 g/m² to about 230 g/m², from about 130 g/m² to about 220 g/m² or from about 140 g/m² to about 210 g/m². In some embodiments, the sheet or shredded sheet has an area density of from about 130 g/m² to about 190 g/m², from about 140 g/m² to about 180 g/m², from about 150 g/m² to about 170 g/m². In a preferred embodiment, the sheet or shredded sheet has an area density of about 160 g/m².

The area density of about 100 g/m² to about 250 g/m² is thought to contribute to the strength and flexibility of sheet or shredded sheet. Furthermore, the inventors have found that a rod comprising a shredded sheet of aerosolisable material having an area density of around 180 gsm and a minimum thickness of 220-230 μm can be can be packed such that the aerosolisable material stays in place within the rod whilst maintaining a desired weight of tobacco material within the rod (e.g. around 300 mg) and delivering acceptable organoleptic properties (e.g. taste and smell) when heated in a non-combustible aerosol provision device.

The flexibility of the sheet or shredded sheet is considered be dependent, at least in part, upon the thickness and area density of the sheet or shredded sheet. A thicker sheet or shredded sheet may be less flexible than a thinner sheet or shredded sheet. Also, the greater the area density of the sheet, the less flexible the sheet or shredded sheet is. It is thought that the combined thickness and area density of the aerosolisable material described herein provides a sheet or shredded sheet that is relatively flexible. When the aerosolisable material is incorporated into an article for use in a non-combustible aerosol-provision device, this flexibility, may give rise to various advantages. For example, the strands or strips are able to readily deform and flex when an aerosol generator is inserted into the aerosol generating material and gathered around the aerosol generator, thus facilitating insertion of an aerosol generator (e.g. a susceptor) into the material and also improving retention of the aerosol generator by the aerosolisable material.

The area density of the sheet or shredded sheet of aerosol-generating material influences the roughness of the first and second surfaces of the sheet or shredded sheet. By changing the area density, the roughness of the first and/or second surfaces can be tailored.

The average volume density of the sheet or shredded sheet of aerosol-generating material may be calculated from the thickness of the sheet and the area density of the sheet. The average volume density may be greater than about 0.2 g/cm³, about 0.3 g/cm³ or about 0.4 g/cm³. In some embodiments, the average volume density is from about 0.2 g/cm³ to about 1 g/cm³, from about 0.3 g/cm³ to about 0.9 g/cm³, from about 0.4 g/cm³ to about 0.9 g/cm³, from about 0.5 g/cm³ to about 0.9 g/cm³ or from about 0.6 g/cm³ to about 0.9 g/cm³.

The aerosol-generating material comprises tobacco material. The sheet or shredded sheet of aerosolisable material comprises tobacco material.

The tobacco material may be a particulate or granular material. In some embodiments, the tobacco material is a powder. Alternatively or in addition, the tobacco material may comprise may comprise strips, strands or fibres of tobacco. For example, the tobacco material may comprise particles, granules, fibres, strips and/or strands of tobacco. In some embodiments, the tobacco material consists of particles or granules of tobacco material.

The density of the tobacco material has an impact on the speed at which heat conducts through the material, with lower densities, for instance those below 900 mg/cc, conducting heat more slowly through the material, and therefore enabling a more sustained release of aerosol.

The tobacco material can comprise reconstituted tobacco material having a density of less than about 900 mg/cc, for instance paper reconstituted tobacco material. For instance, the aerosol-generating material comprises reconstituted tobacco material having a density of less than about 800 mg/cc. Alternatively or in addition, the aerosol-generating material can comprise reconstituted tobacco material having a density of at least 350 mg/cc.

The reconstituted tobacco material can be provided in the form of a shredded sheet. The sheet of reconstituted tobacco material may have any suitable thickness. The reconstituted tobacco material may have a thickness of at least about 0.145 mm, for instance at least about 0.15 mm, or at least about 0.16 mm. The reconstituted tobacco material may have a maximum thickness of about 0.30 mm or 0.25 mm, for instance the thickness of the reconstituted tobacco material may be less than about 0.22 mm, or less than about 0.2 mm. In some embodiments, the reconstituted tobacco material may have an average thickness in the range 0.175 mm to 0.195 mm.

In some embodiments, the tobacco is a particulate tobacco material. Each particle of the particulate tobacco material may have a maximum dimension. As used herein, the term “maximum dimension” refers to the longest straight line distance from any point on the surface of a particle of tobacco, or on a particle surface, to any other surface point on the same particle of tobacco, or particle surface. The maximum dimension of a particle of particulate tobacco material may be measured using scanning electron microscopy (SEM).

The maximum dimension of each particle of tobacco material can be up to about 200 μm. In some embodiments, the maximum dimension of each particle of tobacco material is up to about 150 μm.

A population of particles of the tobacco material may have a particle size distribution (D90) of at least about 100 μm. In some embodiments, a population of particles of the tobacco material has a particle size distribution (D90) of about 110 μm, at least about 120 μm, at least about 130 μm, at least about 140 μm or at least about m. In an embodiment, a population of particles of the tobacco material has a particle size distribution (D90) of about 150 μm. Sieve analysis can also be used to determine the particle size distribution of the particles of tobacco material.

A particle size distribution (D90) of at least about 100 μm is thought to contribute to the tensile strength of the sheet or shredded sheet of aerosolisable material. A particle size distribution (D90) of less than 100 μm provides a sheet or shredded sheet of aerosolisable material having good tensile strength. However, the inclusion of such fine particles of tobacco material in the sheet or shredded sheet can increase its density. When the sheet or shredded sheet is incorporated into an article for use in a non-combustible aerosol provision system, this higher density may decrease the fill-value of the tobacco material. Advantageously, a balance between a satisfactory tensile strength and suitable density (and thus fill-value) may be achieved where the particle size distribution (D90) is at least about 100 μm.

The tobacco material may comprise tobacco obtained from any part of the tobacco plant. In some embodiments, the tobacco material comprises tobacco leaf.

The sheet or shredded sheet can comprise from 5% to about 90% by weight tobacco leaf.

The tobacco material may comprise lamina tobacco and/or tobacco stem, such as midrib stem. The lamina tobacco can be present in an amount of from 0% to about 100%, from about 20% to about 100%, from about 40% to about 100%, from about 40% to about 95%, from about 45% to about 90%, from about 50% to about 85% or from about 55% to about 80% by weight of the sheet or shredded sheet and/or tobacco material. In some embodiments, tobacco material consists or consists essentially of lamina tobacco material.

The tobacco material may comprise tobacco stem in an amount of from 0% to about 100%, from about 0% to about 50%, from about 0 to about 25%, from about 0 to about 20%, from about 5 to about 15% by weight of the sheet or shredded sheet.

In some embodiments, the tobacco material comprises a combination of lamina and tobacco stem. In some embodiments, the tobacco material can comprise lamina in an amount of from about 40% to about 95% and stem in an amount of from about 5% to about 60%, or lamina in an amount of from about 60% to about 95% and stem in an amount of from about 5% to about 40%, or lamina in an amount of from about 80% to about 95% and stem in an amount of from about 5% to about 20% by weight of the sheet or shredded sheet of aerosolisable material.

The sheet or the shredded sheet of aerosolisable material may have a burst strength of at least about 75 g, at least about 100 g or at least about 200 g.

If the burst strength is too low the sheet or shredded sheet may be relatively brittle. As a consequence, breakages in the sheet or shredded sheet may occur during the process of manufacturing the aerosolisable material. For example, when the sheet is shredded to form a shredded sheet by a cutting process, the sheet may shatter or break into pieces or shards when cut.

The tobacco material described herein contains nicotine. The nicotine content is from 0.1 to 3% by weight of the tobacco material, and may be, for example, from 0.5 to 2.5% by weight of the tobacco material. Additionally or alternatively, the tobacco material contains between 10% and 90% by weight tobacco leaf having a nicotine content of greater than about 1% or about 1.5% by weight of the tobacco leaf. The tobacco leaf, for instance cut rag tobacco, can, for instance, have a nicotine content of between 1% and 5% by weight of the tobacco leaf.

The sheet or shredded sheet of aerosolisable material may comprise nicotine in an amount of between about 0.1% to about 3% by weight of the sheet or shredded sheet.

Paper reconstituted tobacco may also be present in the aerosol-generating material described herein. Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The paper reconstituted tobacco may be any type of paper reconstituted tobacco that is known in the art. In a particular embodiment, the paper reconstituted tobacco is made from a feedstock comprising one or more of tobacco strips, tobacco stems, and whole leaf tobacco. In a further embodiment, the paper reconstituted tobacco is made from a feedstock consisting of tobacco strips and/or whole leaf tobacco, and tobacco stems. However, in other embodiments, scraps, fines and winnowings can alternatively or additionally be employed in the feedstock.

The paper reconstituted tobacco for use in the tobacco material described herein may be prepared by methods which are known to those skilled in the art for preparing paper reconstituted tobacco.

In embodiments, the paper reconstituted tobacco is present in an amount of from 5% to 90% by weight, 10% to 80% by weight, or 20% to 70% by weight, of the aerosol-generating material.

The aerosol-generating material comprises an aerosol-former material. The aerosol-former material comprises one or more constituents capable of forming an aerosol. The aerosol-former material comprises one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. Preferably, the aerosol-former material is glycerol or propylene glycol.

The sheet or shredded sheet of aerosolisable material comprises an aerosol-former material. The aerosol-former material is provided in an amount of up to about 50% on a dry weight base by weight of the sheet or shredded sheet. In some embodiments, the aerosol former material is provided in an amount of from about 5% to about 40% on a dry weight base by weight of the sheet or shredded sheet, from about 10% to about 30% on a dry weight base by weight of the sheet or shredded sheet or from about 10% to about 20% on a dry weight base by weight of the sheet or shredded sheet.

The sheet or shredded sheet may also comprise water. The sheet or shredded sheet of aerosolisable material may comprise water in an amount of less than about 15%, less than about 10% or less than about 5% by weight of the aerosolisable material. In some embodiments, the aerosolisable material comprises water in an amount of between about 0% and about 15% or between about 5% and about 15% by weight of the aerosolisable material.

The sheet or shredded sheet of aerosolisable material may comprise water and an aerosol-former material, in a total amount, of less than about 30% by weight of the sheet or shredded sheet of aerosolisable material or less than about 25% by weight of the sheet or shredded sheet of aerosolisable material. It is thought that incorporating water and aerosol-former material in the sheet or shredded sheet of aerosolisable material in an amount of less than about 30% by weight of the sheet or shredded sheet of aerosolisable material may advantageously reduce the tackiness of the sheet. This may improve the ease by which the aerosolisable material can be handled during processing. For example, it may be easier to roll a sheet of aerosolisable material to form a bobbin of material and then unroll the bobbin without the layers of sheet sticking together. Reducing the tackiness may also decrease the propensity for strands or strips of shredded material to clump or stick together, thus further improving processing efficiency and the quality of the final product.

The sheet or shredded sheet comprises a binder. The binder is arranged to bind the components of the aerosol-generating material to form the sheet or shredded sheet. The binder may at least partially coat the surface of the tobacco material. Where the tobacco material is in a particulate form, the binder may at least partially coat the surface of the particles of tobacco and bind them together.

The binder may be selected from one or more compounds selected from the group comprising alginates, pectins, starches (and derivatives), celluloses (and derivatives), gums, silica or silicones compounds, clays, polyvinyl alcohol and combinations thereof. For example, in some embodiments, the binder comprises one or more of alginates, pectins, hydroxyethyl cellulose, hydroxypropyl cellulose, carboxymethylcellulose, pullulan, xanthan gum, guar gum, carrageenan, agarose, acacia gum, fumed silica, PDMS, sodium silicate, kaolin and polyvinyl alcohol. In some cases, the binder comprises alginate and/or pectin or carrageenan. In a preferred embodiment, the binder comprises guar gum.

The binder may be present in an amount of from about 1 to about 20% by weight of the sheet or shredded sheet, or in an amount of from 1 to about 10% by weight of the sheet or shredded sheet of aerosolisable material. For example, the binder may be present in an amount of about 1%, 2%, 3%, 4%, 5%, 6%, 7%, 8%, 9% or 10% by weight of the sheet or shredded sheet of aerosolisable material.

The aerosol-generating material may comprise a filler. In some embodiments, the sheet or shredded sheet comprises the filler. The filler is generally a non-tobacco component, that is, a component that does not include ingredients originating from tobacco. The filler may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may be a non-tobacco fibre such as wood fibre or pulp or wheat fibre. The filler can be a material comprising cellulose or a material comprises a derivate of cellulose. The filler component may also be a non-tobacco cast material or a non-tobacco extruded material.

In particular embodiments which include filler, the filler is fibrous. For example, the filler may be a fibrous organic filler material such as wood, wood pulp, hemp fibre, cellulose or cellulose derivatives. Without wishing to be bound by theory, it is believed that including fibrous filler may increase the tensile strength of the material.

The filler may also contribute to the texture of the sheet or shredded sheet of the aerosolisable material. For example, a fibrous filler, such as wood or wood pulp, may provide a sheet or shredded sheet of aerosolisable material having relatively rough first and second surfaces. Conversely, a non-fibrous, particulate filler, such as powdered chalk, may provide a sheet or shredded sheet of aerosolisable material having relatively smooth first and second surfaces. In some embodiments, the aerosolisable material comprises a combination of different filler materials.

The filler component may be present in an amount of 0 to 20% by weight of the sheet or shredded sheet, or in an amount of from 1 to 10% by weight of the sheet or shredded sheet. In some embodiments, the filler component is absent.

The filler may help to improve the general structural properties of the aerosolisable material, such as its tensile strength and burst strength.

In the compositions described herein, where amounts are given in % by weight, for the avoidance of doubt this refers to a dry weight basis, unless specifically indicated to the contrary. Thus, any water that may be present in the aerosol-generating material, or in any component thereof, is entirely disregarded for the purposes of the determination of the weight %. The water content of the aerosol-generating material described herein may vary and may be, for example, from 5 to 15% by weight. The water content of the aerosol-generating material described herein may vary according to, for example, the temperature, pressure and humidity conditions at which the compositions are maintained. The water content can be determined by Karl-Fisher analysis, as known to those skilled in the art. On the other hand, for the avoidance of doubt, even when the aerosol-former material is a component that is in liquid phase, such as glycerol or propylene glycol, any component other than water is included in the weight of the aerosol-generating material. However, when the aerosol-former material is provided in the tobacco component of the aerosol-generating material, or in the filler component (if present) of the aerosol-generating material, instead of or in addition to being added separately to the aerosol-generating material, the aerosol-former material is not included in the weight of the tobacco component or filler component, but is included in the weight of the “aerosol-former material” in the weight % as defined herein. All other ingredients present in the tobacco component are included in the weight of the tobacco component, even if of non-tobacco origin (for example non-tobacco fibres in the case of paper reconstituted tobacco).

The aerosol-generating material herein can comprise an aerosol modifying agent, such as any of the flavours described herein. In one embodiment, the aerosol-generating material comprises menthol. When the aerosol-generating material is incorporated into an article for use in an aerosol-provision system, the article may be referred to as a mentholated article. The aerosol-generating material can comprise from 0.5 mg to 20 mg of menthol, from 0.7 mg to 20 mg of menthol, between 1 mg and 18 mg or between 8 mg and 16 mg of menthol. In the present example, the aerosol-generating material comprises 16 mg of menthol. The aerosol-generating material can comprise between 1% and 8% by weight of menthol, preferably between 3% and 7% by weight of menthol and more preferably between 4% and 5.5% by weight of menthol. In one embodiment, the aerosol-generating material comprises 4.7% by weight of menthol. Such high levels of menthol loading can be achieved using a high percentage of reconstituted tobacco material, for instance greater than 50% of the tobacco material by weight. Alternatively or additionally, the use of a high volume of, for instance tobacco material, can increase the level of menthol loading that can be achieved, for instance where greater than about 500 mm³ or suitably more than about 1000 mm³ of aerosol-generating material, such as tobacco material, are used.

In some embodiments, the composition comprises an aerosol-forming “amorphous solid”, which may alternatively be referred to as a “monolithic solid” (i.e. non-fibrous). In some embodiments, the amorphous solid may comprise a dried gel. The amorphous solid is a solid material that may retain some fluid, such as liquid, within it.

In some examples, the amorphous solid comprises:
1-60 wt % of a gelling agent;
0.1-50 wt % of an aerosol-former material; and
0.1-80 wt % of a flavour;

wherein these weights are calculated on a dry weight basis.

In some further embodiments, the amorphous solid comprises:
1-50 wt % of a gelling agent;
0.1-50 wt % of an aerosol-former material; and
30-60 wt % of a flavour;

wherein these weights are calculated on a dry weight basis.

The amorphous solid material may be provided in sheet or in shredded sheet form. The amorphous solid material may take the same form as the sheet or shredded sheet of aerosolisable material described previously.

Suitably, the amorphous solid may comprise from about 1 wt %, 5 wt %, 10 wt %, 15 wt %, 20 wt % or 25 wt % to about 60 wt %, 50 wt %, 45 wt %, 40 wt % or 35 wt % of a gelling agent (all calculated on a dry weight basis). For example, the amorphous solid may comprise 1-50 wt %, 5-45 wt %, 10-40 wt % or 20-35 wt % of a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the amorphous solid. In some cases, the amorphous solid may comprise a calcium-crosslinked alginate and/or a calcium-crosslinked pectin.

In some embodiments, the gelling agent comprises alginate, and the alginate is present in the amorphous solid in an amount of from 10-30 wt % of the amorphous solid (calculated on a dry weight basis). In some embodiments, alginate is the only gelling agent present in the amorphous solid. In other embodiments, the gelling agent comprises alginate and at least one further gelling agent, such as pectin.

In some embodiments the amorphous solid may include gelling agent comprising carrageenan.

Suitably, the amorphous solid may comprise from about 0.1 wt %, 0.5 wt %, 1 wt %, 3 wt %, 5 wt %, 7 wt % or 10% to about 50 wt %, 45 wt %, 40 wt %, 35 wt %, 30 wt % or 25 wt % of an aerosol-former material (all calculated on a dry weight basis). The aerosol-former material may act as a plasticiser. For example, the amorphous solid may comprise 0.5-40 wt %, 3-35 wt % or 10-25 wt % of an aerosol-former material. In some cases, the aerosol-former material comprises one or more compound selected from erythritol, propylene glycol, glycerol, triacetin, sorbitol and xylitol. In some cases, the aerosol-former material comprises, consists essentially of or consists of glycerol.

The amorphous solid comprises a flavour. Suitably, the amorphous solid may comprise up to about 80 wt %, 70 wt %, 60 wt %, 55 wt %, 50 wt % or 45 wt % of a flavour.

In some cases, the amorphous solid may comprise at least about 0.1 wt %, 1 wt %, 10 wt %, 20 wt %, 30 wt %, 35 wt % or 40 wt % of a flavour (all calculated on a dry weight basis).

For example, the amorphous solid may comprise 1-80 wt %, 10-80 wt %, 20-70 wt %, 30-60 wt %, 35-55 wt % or 30-45 wt % of a flavour. In some cases, the flavour comprises, consists essentially of or consists of menthol.

In some cases, the amorphous solid may additionally comprise an emulsifying agent, which emulsified molten flavour during manufacture. For example, the amorphous solid may comprise from about 5 wt % to about 15 wt % of an emulsifying agent (calculated on a dry weight basis), suitably about 10 wt %. The emulsifying agent may comprise acacia gum.

In some embodiments, the amorphous solid is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

In some embodiments, the amorphous solid additionally comprises an active substance. For example, in some cases, the amorphous solid additionally comprises a tobacco material and/or nicotine. In some cases, the amorphous solid may comprise 5-60 wt % (calculated on a dry weight basis) of a tobacco material and/or nicotine. In some cases, the amorphous solid may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance. In some cases, the amorphous solid may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the amorphous solid may comprise 10-50 wt %, 15-40 wt % or 20-35 wt % of a tobacco material. In some cases, the amorphous solid may comprise from about 1 wt %, 2 wt %, 3 wt % or 4 wt % to about 20 wt %, 18 wt %, 15 wt % or 12 wt % (calculated on a dry weight basis) of nicotine. For example, the amorphous solid may comprise 1-20 wt %, 2-18 wt % or 3-12 wt % of nicotine.

In some cases, the amorphous solid comprises an active substance such as tobacco extract. In some cases, the amorphous solid may comprise 5-60 wt % (calculated on a dry weight basis) of tobacco extract. In some cases, the amorphous solid may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the amorphous solid may comprise 10-50 wt %, 15-40 wt % or 20-35 wt % of tobacco extract. The tobacco extract may contain nicotine at a concentration such that the amorphous solid comprises 1 wt % 1.5 wt %, 2 wt % or 2.5 wt % to about 6 wt %, 5 wt %, 4.5 wt % or 4 wt % (calculated on a dry weight basis) of nicotine.

In some cases, there may be no nicotine in the amorphous solid other than that which results from the tobacco extract.

In some embodiments the amorphous solid comprises no tobacco material but does comprise nicotine. In some such cases, the amorphous solid may comprise from about 1 wt %, 2 wt %, 3 wt % or 4 wt % to about 20 wt %, 18 wt %, 15 wt % or 12 wt % (calculated on a dry weight basis) of nicotine. For example, the amorphous solid may comprise 1-20 wt %, 2-18 wt % or 3-12 wt % of nicotine.

In some cases, the total content of active substance and/or flavour may be at least about 0.1 wt %, 1 wt %, 5 wt %, 10 wt %, 20 wt %, 25 wt % or 30 wt %. In some cases, the total content of active substance and/or flavour may be less than about 90 wt %, 80 wt %, 70 wt %, 60 wt %, 50 wt % or 40 wt % (all calculated on a dry weight basis).

In some cases, the total content of tobacco material, nicotine and flavour may be at least about 0.1 wt %, 1 wt %, 5 wt %, 10 wt %, 20 wt %, 25 wt % or 30 wt %. In some cases, the total content of active substance and/or flavour may be less than about 90 wt %, 80 wt %, 70 wt %, 60 wt %, 50 wt % or 40 wt % (all calculated on a dry weight basis).

The amorphous solid may be made from a gel, and this gel may additionally comprise a solvent, included at 0.1-50 wt %. However, the inventors have established that the inclusion of a solvent in which the flavour is soluble may reduce the gel stability and the flavour may crystallise out of the gel. As such, in some cases, the gel does not include a solvent in which the flavour is soluble.

In some embodiments, the amorphous solid comprises less than 60 wt % of a filler, such as from 1 wt % to 60 wt %, or 5 wt % to 50 wt %, or 5 wt % to 30 wt %, or 10 wt % to 20 wt %.

In other embodiments, the amorphous solid comprises less than 20 wt %, suitably less than 10 wt % or less than 5 wt % of a filler. In some cases, the amorphous solid comprises less than 1 wt % of a filler, and in some cases, comprises no filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives. In particular cases, the amorphous solid comprises no calcium carbonate such as chalk.

In particular embodiments which include filler, the filler is fibrous. For example, the filler may be a fibrous organic filler material such as wood pulp, hemp fibre, cellulose or cellulose derivatives. Without wishing to be bound by theory, it is believed that including fibrous filler in an amorphous solid may increase the tensile strength of the material.

In some embodiments, the amorphous solid does not comprise tobacco fibres.

In some examples, the amorphous solid in sheet form may have a tensile strength of from around 200 N/m to around 1500 N/m. In some examples, such as where the amorphous solid does not comprise a filler, the amorphous solid may have a tensile strength of from 200 N/m to 400 N/m, or 200 N/m to 300 N/m, or about 250 N/m. Such tensile strengths may be particularly suitable for embodiments wherein the amorphous solid material is formed as a sheet and then shredded and incorporated into an aerosol-generating article.

In some examples, such as where the amorphous solid comprises a filler, the amorphous solid may have a tensile strength of from 600 N/m to 1500 N/m, or from 700 N/m to 900 N/m, or around 800 N/m. Such tensile strengths may be particularly suitable for embodiments wherein the amorphous solid material is included in an aerosol-generating article as a rolled sheet, suitably in the form of a tube.

In some cases, the amorphous solid may consist essentially of, or consist of a gelling agent, water, an aerosol-former material, a flavour, and optionally an active substance.

In some cases, the amorphous solid may consist essentially of, or consist of a gelling agent, water, an aerosol-former material, a flavour, and optionally a tobacco material and/or a nicotine source.

The amorphous solid may comprise one or more active substances and/or flavours, one or more aerosol-former materials, and optionally one or more other functional material.

The aerosol-generating material can comprise a paper reconstituted tobacco material. The composition can alternatively or additionally comprise any of the forms of tobacco described herein. The aerosol generating material can comprise a sheet or shredded sheet comprising tobacco material comprising between 10% and 90% by weight tobacco leaf, wherein an aerosol-former material is provided in an amount of up to about 20% by weight of the sheet or shredded sheet, and the remainder of the tobacco material comprises paper reconstituted tobacco.

Where the aerosol-generating material comprises an amorphous solid material, the amorphous solid material may be a dried gel comprising menthol. In alternative embodiments, the amorphous solid may have any composition as described herein.

The inventors have advantageously found that an improved article may be produced comprising aerosol-generating material comprising a first component comprising a sheet or shredded sheet of aerosolisable material and a second component comprising amorphous solid, wherein the material properties (e.g. density) and specification (e.g. thickness, length, and cut width) fall within the ranges set out herein.

In some cases, the amorphous solid may have a thickness of about 0.015 mm to about 1.0 mm. Suitably, the thickness may be in the range of about 0.05 mm, 0.1 mm or 0.15 mm to about 0.5 mm or 0.3 mm. The inventors have found that a material having a thickness of about 0.09 mm can be used. The amorphous solid may comprise more than one layer, and the thickness described herein refers to the aggregate thickness of those layers.

The thickness of the amorphous solid material may be measured using a caliper or a microscope such as a scanning electron microscope (SEM), as known to those skilled in the art, or any other suitable technique known to those skilled in the art.

If the amorphous solid is too thick, then heating efficiency can be compromised. This can adversely affect power consumption in use, for instance the power consumption for release of flavour from the amorphous solid. Conversely, if the aerosol-forming amorphous solid is too thin, it can be difficult to manufacture and handle; a very thin material can be harder to cast and may be fragile, compromising aerosol formation in use. In some cases, an individual strip or piece of the amorphous solid has a minimum thickness over its area of about 0.015. In some cases, an individual strip or piece of the amorphous solid has a minimum thickness over its area of about 0.05 mm or about 0.1 mm. In some cases, an individual strip or piece of the amorphous solid has a maximum thickness over its area of about 1.0 mm. In some cases, an individual strip or piece of the amorphous solid has a maximum thickness over its area of about 0.5 mm or about 0.3 mm.

In some cases, the amorphous solid thickness may vary by no more than 25%, 20%, 15%, 10%, 5% or 1% across its area.

Providing amorphous solid material and sheet or shredded sheet of aerosolisable material having area density values that differ from each other by less than a given percentage results in less separation in a mixture of these materials. In some examples, the area density of the amorphous solid material may be between 50% and 150% of the area density of the aerosolisable material. For instance, the area density of the amorphous solid material may be between 60% and 140% of the density of the aerosolisable material, or between 70% and 110% of the area density of the aerosolisable material, or between 80% and 120% of the area density of the aerosolisable material.

In embodiments described herein, the amorphous solid material may be incorporated into the article in sheet form. The amorphous solid material in sheet form may be shredded and then incorporated into the article, suitably mixed into with an aerosolisable material, such as the sheet or shredded sheet of aerosolisable material described herein.

In further embodiments the amorphous solid sheet may additionally be incorporated as a planar sheet, as a gathered or bunched sheet, as a crimped sheet, or as a rolled sheet (i.e. in the form of a tube). In some such cases, the amorphous solid of these embodiments may be included in an aerosol-generating article as a sheet, such as a sheet circumscribing a rod comprising aerosolisable material. For example, the amorphous solid sheet may be formed on a wrapping paper which circumscribes an aerosolisable material such as tobacco.

The amorphous solid in sheet form may have any suitable area density, such as from about 30 g/m² to about 150 g/m². In some cases, the sheet may have a mass per unit area of about 55 g/m² to about 135 g/m², or about 80 to about 120 g/m², or from about 70 to about 110 g/m², or particularly from about 90 to about 110 g/m², or suitably about 100 g/m². These ranges can provide a density which is similar to the density of cut rag tobacco and as a result a mixture of these substances can be provided which will not readily separate. Such area densities may be particularly suitable where the amorphous solid material is included in an aerosol-generating article as a shredded sheet (described further hereinbelow). In some cases, the sheet may have a mass per unit area of about 30 to 70 g/m², 40 to 60 g/m², or 25 to 60 g/m² and may be used to wrap an aerosolisable material, such as the aerosolisable material described herein.

The aerosol-generating material may comprise a blend of the aerosolisable material and the amorphous solid material as described herein. Such aerosol-generating material can provide an aerosol, in use, with a desirable flavour profile, since additional flavour may be introduced to the aerosol-generating material by inclusion in the amorphous solid material component. Flavour provided in the amorphous solid material may be more stably retained within the amorphous solid material compared to flavour added directly to the tobacco material, resulting in a more consistent flavour profile between articles produced according to this disclosure.

As described above, tobacco material having a density of at least 350 mg/cc and less than about 900 mg/cc, preferably between about 600 mg/cc and about 900 mg/cc, has been advantageously found to result in a more sustained release of aerosol. To provide an aerosol having a consistent flavour profile the amorphous solid material component of the aerosol-generating material should be evenly distributed throughout the rod. The inventors have advantageously found that this can be achieved by casting the amorphous solid material to have a thickness as described herein, to provide an amorphous solid material having an area density which is similar to the area density of the tobacco material, and processing the amorphous solid material as described hereinbelow to ensure an even distribution throughout the aerosol-generating material.

As noted above, optionally, the aerosol-generating material comprises a plurality of strips of amorphous solid material. Where the aerosol generating section comprises a plurality of strands and/or strips of the sheet of aerosolisable material and a plurality of strips of amorphous solid material, the material properties and/or dimensions of the at least two components may be suitably selected in other ways, to ensure a relatively uniform mix of the components is possible, and to reduce separation or un-mixing of the components during or after manufacture of the rod of aerosol-generating material.

The longitudinal dimension of the plurality of strands or strips may be substantially the same as a length of the aerosol generating section. The plurality of strands and/or strips may have a length of at least about 5 mm.

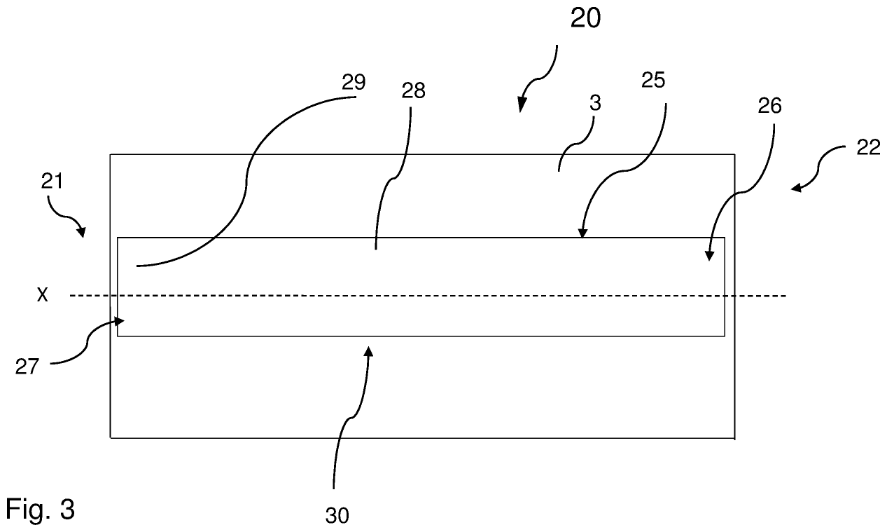

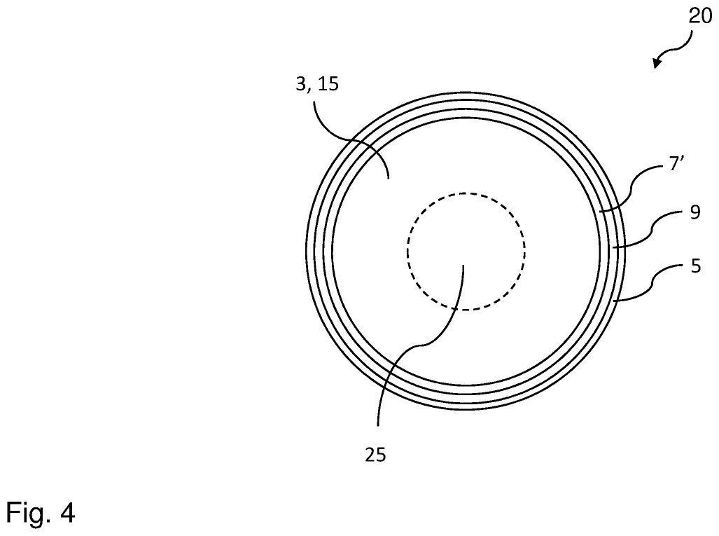

Referring to FIGS. 3 and 4, the aerosol-generating material segment 20 is shown. The aerosol-generating material segment 20 comprises a first end 21 and an opposing second end 22. The first end 21 of the aerosol-generating material segment 20 is located proximate to the mouthpiece 2. The second end 22 of the aerosol-generating material segment 20 is located distal to the mouthpiece 2 and forms a free end of the article 1.

The aerosol-generating material segment 20 further comprises a susceptor 25 located within the aerosol-generating material 3. The susceptor 25 comprises a first end 26 and an opposing second end 27. The first end 26 of the susceptor 25 is located proximate to the first end 21 of the aerosol-generating material segment 20. The second end 27 of the susceptor 25 is located proximate to the second end 22 of the aerosol-generating material segment 20.

The first end 26 of the susceptor 25 is located within about 1 mm to 3 mm, in some embodiments 2 mm, of the first end 21 of the aerosol-generating material segment 20. The second end 27 of the susceptor 25 is located within about 1 mm to 3 mm, in some embodiments 2 mm, of the second end 22 of the aerosol-generating material segment 20. In some embodiments, as illustrated in FIG. 3, the ends 26, 27 of the susceptor 25 are spaced from the ends 21, 22 of the aerosol-generating material segment 20.

In some embodiments, the susceptor 25 extends the full length of the aerosol-generating material segment 20. That is, the first end 26 of the susceptor 25 is located at the extremity of the first end 21 of the aerosol-generating material segment 20, and the second end 27 of the susceptor 25 is located at the extremity of the second end 22 of the aerosol-generating material segment 20.

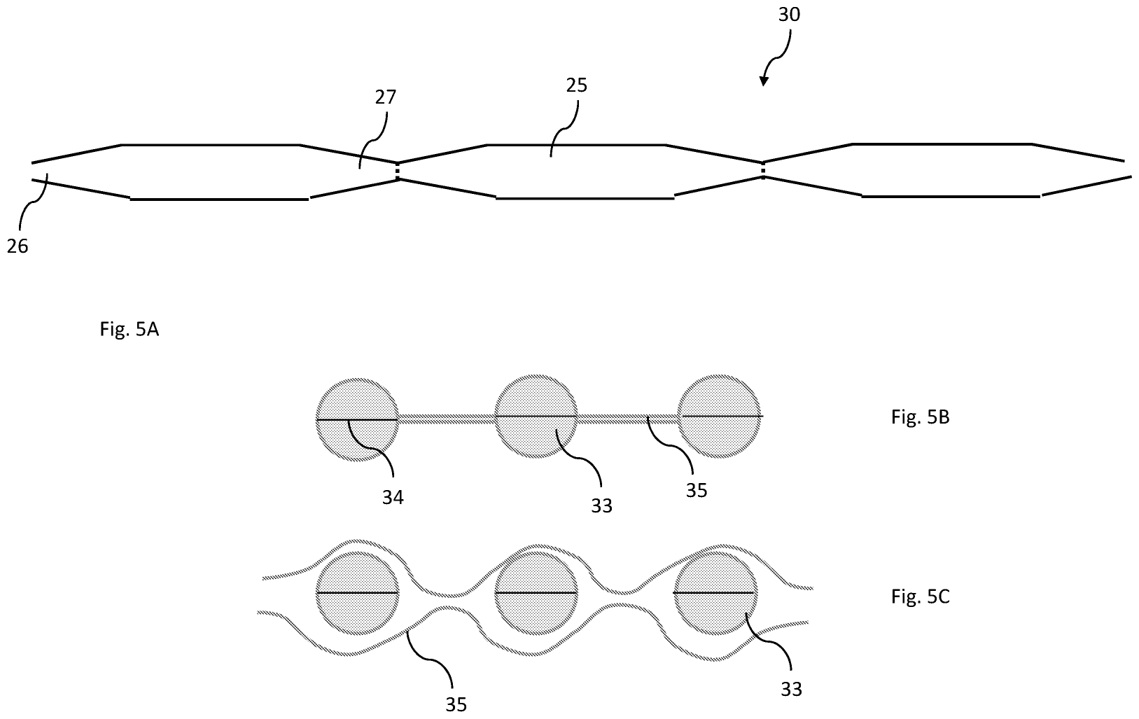

In some embodiments, the susceptor 25 may comprise a flat sheet as shown in FIG. 3, cylindrical rod, as shown in FIG. 4, or a thread. In another embodiment, the susceptor 25 may be formed from a chain of substantially spherical elements 33, as shown in FIGS. 5B and 5C. The spherical elements 33 are formed from a flat sheet of susceptor material 30 which is folded into a spherical shape. Therefore, the spherical elements 33 may comprise a slit 34. In other embodiments, the spherical elements 33 may be moulded and so the slit 34 may be omitted. Preferably, the spherical elements 33 are hollow.

Furthermore, the susceptor 25 comprises a joining material 35. The joining material 35 is configured to join the substantially spherical elements 33 together. Preferably, the joining material 35 is formed from a non-susceptor material. More preferably, the joining material 35 is formed from a fibrous thread. Therefore, the joining material 35 is easier to cut through than the susceptor material 30.

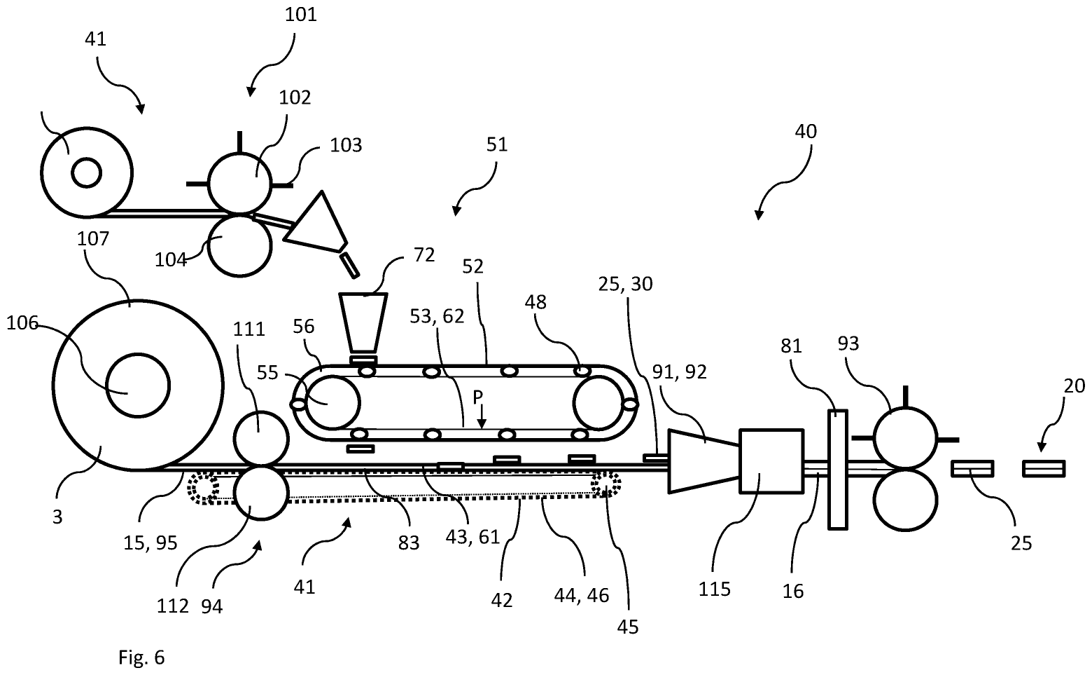

Referring now to FIG. 6, a schematic side view of an apparatus 40 for manufacturing aerosol-generating segments 20 for an article 1 described above with reference to FIGS. 3 and 4 is shown. The apparatus 40 is configured to position a ferrous susceptor element 25 relative to an aerosol-generating material 3 formed from aerosol generating material 3. The apparatus 40 is further configured to form a continuous aerosol-generating material rod 16 comprising at least one susceptor before cutting the continuous rod into individual segments 20

The apparatus 40 comprises an aerosol-generating material receiving section 41. The aerosol-generating material receiving section 41 is configured to receive an aerosol-generating material 15. The aerosol generating material receiving section 41 comprises an aerosol-generating material transporter 42. The aerosol-generating material transporter 42 is configured to transport an aerosol-generating material 15 along a first path 43.

In some embodiments, the aerosol-generating material transporter 42 may comprise an endless conveyor 44, shown in dotted lines. The endless conveyor 44 may comprise a plurality of drums 45 and an endless belt 46. The drums 45 may be rotated to move the belt 46 and thus the aerosol-generating material 3 received thereon.

The apparatus 40 further comprises at least one magnet 48. The at least one magnet 48 is configured to position a ferrous susceptor element 25 in a first predetermined position relative to an aerosol-generating material 3 received in the aerosol-generating material receiving section 41.

The at least one magnet 48 has a first operative state and a second operative state. When the at least one magnet 48 is in the first operative state, the at least one magnet is operative to exert a moving force on a ferrous susceptor element 25. That is, the at least one magnet 48 is capable of providing a magnetic force that acts against gravity to at least suspend a ferrous susceptor element in an unsupported position, i.e. without physical contact from below, or a magnetic force strong enough to move a ferrous susceptor element 25 relative to the at least one magnet 48.

In some embodiments, when the at least one magnet 48 is in the second operative state, the at least one magnet 48 may be unable to exert a moving force on a ferrous susceptor element 25, i.e. the at least one magnet 48 may be non-operative. That is, the at least one magnet 48 may be unable to provide a magnetic force that is able to suspend a ferrous susceptor element against gravity or provide a strong enough magnetic force to move a ferrous susceptor element relative to the at least one magnet 48.

In other embodiments, when the at least one magnet 48 is in the second operative state, the at least one magnet 48 may be able to exert a moving force on a ferrous susceptor element 25. That is, the at least one magnet 48 is capable of providing a magnetic force that acts against gravity to at least suspend a ferrous susceptor element in an unsupported position, i.e. without physical contact from below, or a magnetic force strong enough to move a ferrous susceptor element 25 relative to the at least one magnet 48. The magnetic force provided in the second operative state of the at least one magnet 48 may be opposite to the moving force applied in the first operative state.

The at least one magnet 48 may be selectively moved between the first operative state and the second operative state to position the susceptor 25 in the correct position. The magnetic force provided may be either to attract the ferrous susceptor element 25 towards the at least one magnet 48 or to repel the ferrous susceptor element 25 from the at least one magnet 48.

The apparatus 40 further comprises a susceptor inserter 51. The susceptor inserter 51 is configured to insert a susceptor 25 into the aerosol-generating material moving along the first path 43. The susceptor inserter 51 comprises a susceptor transporter 52. The susceptor transporter 52 is configured to transport a ferrous susceptor element 25 along a second path 53.

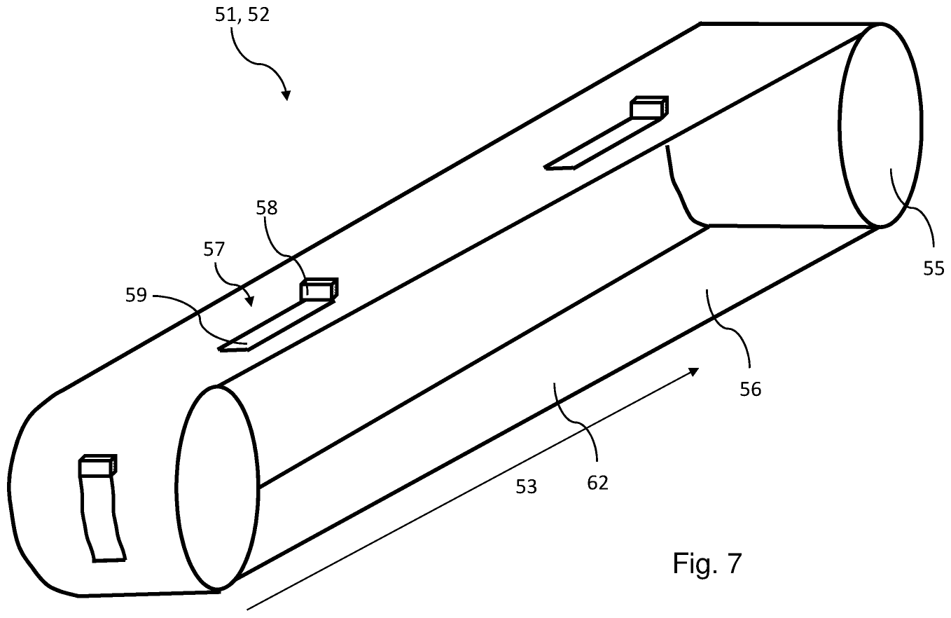

In the embodiment shown in FIGS. 6 and 7, the susceptor transporter 53 comprises an endless conveyor 54, shown in dotted lines. The endless conveyor 54 may comprise a plurality of drums 55 and an endless belt 56. The drums 55 may be rotated to move the belt 56 and thus the susceptors 25 received thereon.

The belt 57 may comprises a susceptor receiving device 57, as shown in FIG. 7. In some embodiments, the belt 56 may comprise at least one projection 58. The projection 58 may be configured to contact an end of a susceptor 25 to push it along the second path 53 as the belt 56 moves. In some embodiments, the belt 56 may comprise at least one groove 59, or recess, configured to receive a susceptor 25. The at least one groove may be a plurality of discrete grooves or a single continuous groove. An end wall of the groove 59 may perform the same function as the projection 57 mentioned above. In other embodiments, the susceptor receiving device 57 of the belt 56 may comprise a pair of arms, which are configured to receive a susceptor in a snap fit arrangement, as will be described in more detail hereinafter.

The at least one magnet 48 is configured to be selectively operated along the second path 53 in order to insert a ferrous susceptor element 25 into an aerosol-generating material 3 being transported along the first path 43 at a predefined insertion point P.

The predefined insertion point P may be located on overlapping sections 61, 62 of the first and second paths 43, 53. An overlapping section may be considered to be sections of the first and second paths 43, 53 which are vertically aligned, such that one of the first and second paths 43, 53 is aligned vertically above the other of the first and second paths 43, 53.

Thus, the at least one magnet 48 may be selectively moved from the first operative state to a second operative state to move a susceptor 25 from the susceptor transporter 52 to the aerosol-generating material 3 on the aerosol-generating material transporter 52. Therefore, moving the at least one magnet 48 from the first operative state to the second operative state inserts a susceptor element 25 at least on to an aerosol-generating material 3.

As shown in FIG. 6, in the present embodiment, the susceptor transporter 52 is located vertically above the aerosol-generating material transporter 42. In some embodiments, only the overlapping section 62 of the second path 53 of the susceptor transporter 52 is located vertically above the overlapping section 61 of the first path 43 of the aerosol-generating material transporter 42. The overlapping sections 61, 62 of the first and second paths 43, 53 face each other.

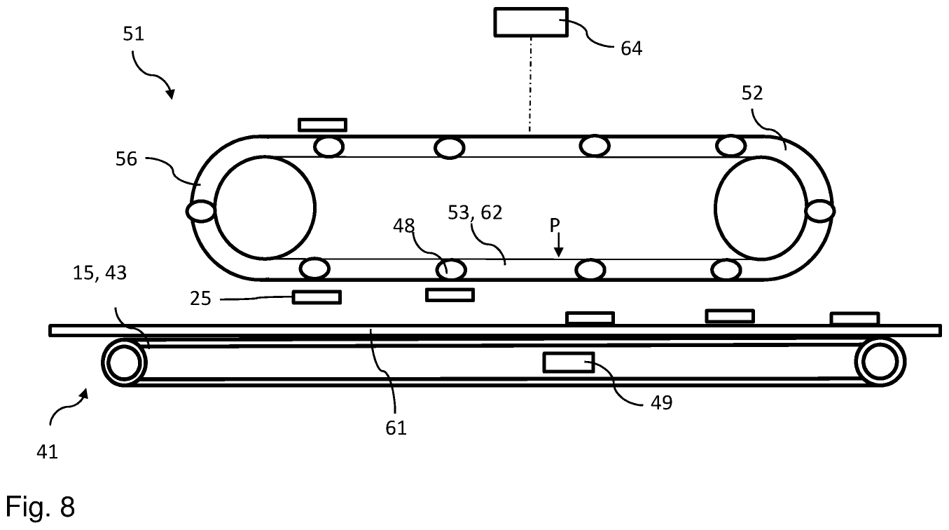

Referring to FIG. 8, a schematic cross-sectional view of the aerosol-generating material receiving section 41 and the susceptor inserter 51 is shown. In the present embodiment, the at least one magnet 48 is located above at least a portion of the susceptor transporter 52. The at least one magnet 48 is also located above the overlapping section 62 of the second path 53 of the susceptor transporter 52. When the at least one magnet 48 is located above the predefined insertion point P, the at least one magnet 48 is configured to be selectively moved from one state to the other state to insert a susceptor into the first path 43 of the aerosol-generating material 3.

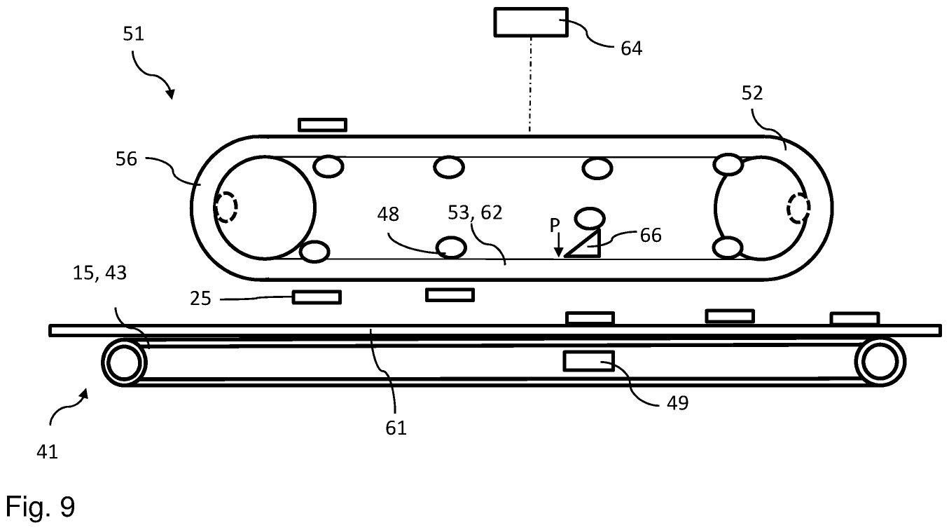

In the present embodiment, the at least one magnet 48 is moveable along a path 63 which overlaps the overlapping portions 61, 62 of the first and second paths 43, 53. As shown in FIG. 8, in the present embodiment, the at least magnet 48 is located in the conveyor belt 56. Thus, the at least one magnet 48 is above the outer surface of the belt 56 when the magnet 48 is above the overlapping portions 61, 62 of the first and second paths 43, 53. It will be appreciated that in alternative embodiments, the at least one magnet may be located on the inner surface of the conveyor belt 56, as shown in FIG. 9.

The at least one magnet 48 may be an electromagnet. The at least one electromagnet 48 is powered by a power source 64. The power source is configured to power the at least one electromagnet 48 is the first operative state and to switch the at least one electromagnet 48 into the second operative state at the predefined insertion point P.

Therefore, in one embodiment, the at least one electromagnet 48 is in its first operative state on the second path 53 until the predefined insertion point is reached. In such a first operative state, the at least one electromagnet 48 exerts an attractive magnetic force on the susceptor 25 to hold the susceptor 25 against the susceptor transporter 52.

Once the predefined insertion point is reached, the at least one electromagnet is switched into its second operative state, in which power to the at least one electromagnet can be removed, or at least reduced, such that the susceptor 25 falls under gravity into the first path 43 of the aerosol-generating material 3. Alternatively, in the second operative state, the at least one electromagnet 48 may provide a repulsive magnetic force to aid in insertion of the susceptor by pushing it away from the susceptor transporter 52. In some embodiments, pneumatic jets may be used in addition to aid with susceptor insertion.

In another embodiment as illustrated in FIG. 9, the at least one magnet 48 may be a permanent magnet. Therefore, the magnetic field of the permanent magnet 48 cannot be adjusted as with the electromagnet embodiment above. Thus, in order to move the at least one magnet 48 from its first operative position to a second operative position, the at least one magnet 48 is moveable in a direction away from the second path 53 of the susceptor 25 to move the at least one permanent magnet 48 into its second operative state. By increasing the distance between the at least one permanent magnet 48 and the susceptor 25 on the second path 53 of the second transporter 52, the magnetic force exerted on the susceptor 25 is weakened, which allows the susceptor to fall under gravity or otherwise be moved from the susceptor inserter 51 into the aerosol-generating material 3 on the aerosol-generating material receiving section 41.

The at least one permanent magnet 48 may be moved by, for example, but not limited to, a tongue 66 which is configured to temporarily separate the at least one permanent magnet 48 form the second transporter 52 at the predefined insertion point P. The at least one permanent magnet 48 may be attached to the susceptor transporter 52 by a resiliently deformable material which allows the permanent magnet 48 to be moved back to its original position relative to the susceptor transporter 52 once the at least one magnet 48 has passed the tongue 66.

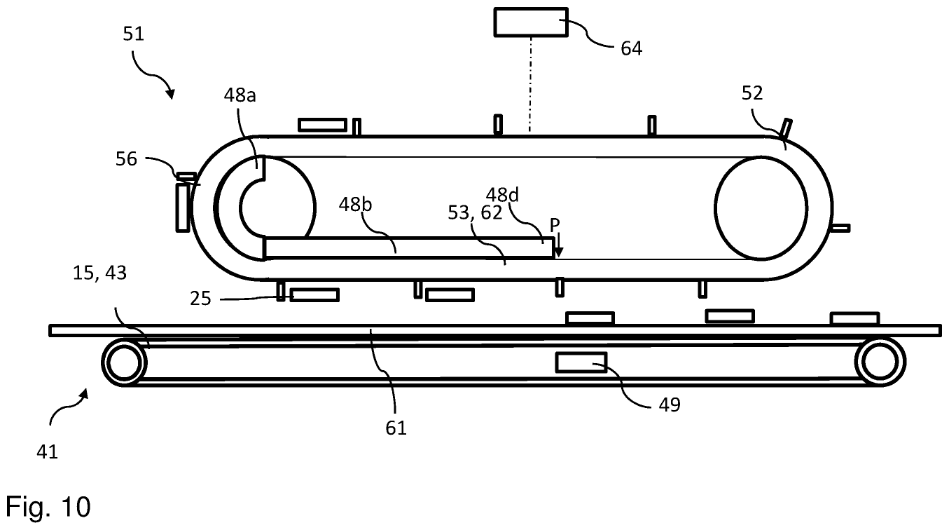

Referring now to FIG. 10, a schematic cross-sectional view of the aerosol-generating material receiving section 41 and the susceptor inserter 51 is shown. This embodiment differs from those described above in that the at least one magnet 48 is stationary. The at least one magnet 48 is located on the inside of the susceptor transporter 52 and is therefore located above at least a portion of the transporter 52. In the present embodiment, the at least one magnet 48 is located proximate to the inner surface of the conveyor belt 56.

In the present embodiment, the at least one magnet 48 comprises an arcuate magnet 48a and a straight magnet 48b, although it will be appreciated that other arrangements in terms of number of magnets and shape are possible. The arcuate magnet 48a holds the susceptor 25 to the susceptor transporter 52 as the susceptor travels around the drum. The straight magnet 48 then transfers the susceptor 25 towards the predefined insertion point P.

The at least one magnet 48 comprises a downstream end 48d. The downstream end 48d is located upstream of the predefined insertion point P such that when the ferrous susceptor element 25 passes the at least one magnet 48, the at least one magnet is in a second operative state in which it is unable to attract the ferrous susceptor element towards it. That is, as the distance between the susceptor 25 and the downstream end 48d of the at least one magnet 48 increases, the magnetic force applied by the at least one magnet 48 on the susceptor 25 reduces until the magnet 48 can no longer hold the susceptor against the susceptor transporter 52. In such an example, the at least one magnet 48 may be either a permanent magnet or an electromagnet.

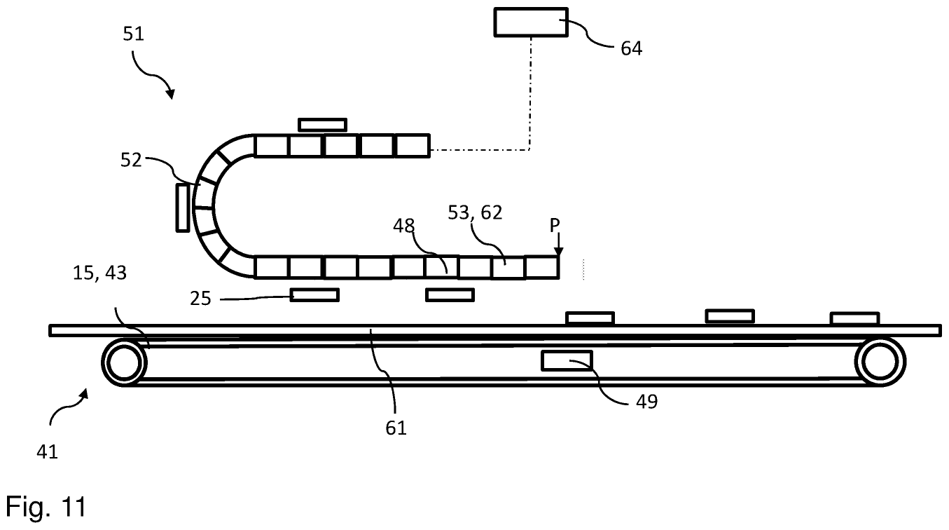

Referring to FIG. 11, a schematic cross-sectional view of the aerosol-generating material receiving section 41 and the susceptor inserter 51 is shown. In the present embodiment, the at least one stationary magnet 48 comprises a plurality of electromagnets. The plurality of electromagnets 48 are configured to act as a linear induction motor. Therefore, the plurality of electromagnets 48 form the susceptor transporter 52.

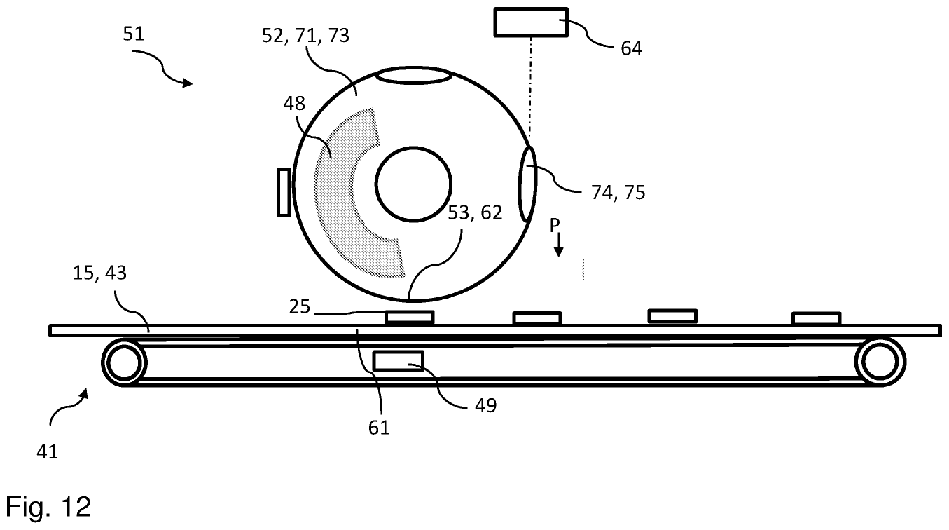

In another embodiment, shown in FIG. 12, the susceptor transporter 51 may comprise a rotary feed mechanism 71. The feed mechanism 71 may receive individual susceptors 25 from the hopper 72 or other source of susceptors 25. The feed mechanism 61 may comprises a delivery wheel 73. The delivery wheel 73 may receive susceptors from the hopper 72 or a feed disk between the hopper 72 and the delivery wheel 73. The delivery wheel 73 comprises a plurality of susceptor receiving pockets 74 in the form of holes or grooves 75. The delivery wheel 73 is configured to rotate and to successively deliver the susceptors 25 into the flow of aerosol-generating material 3 passing through the apparatus 40.

Adjacent pockets 74 may be spaced circumferentially by a distance equal to the gap desired between adjacent susceptors 25 in the aerosol-generating material rod 45, and the rotary speed of the delivery wheel 73 may be matched to the speed of the flow of the aerosol-generating material 3 along its flow path.

In addition, the delivery wheel 73 may be provided with a suction housing arranged to assist transfer of the susceptors 25 from the hopper 72 or feed disk into the pockets of the delivery wheel 73, and to maintain the susceptors 25 in the holes 75 until they are ejected into the aerosol-generating material 3. The delivery wheel 73 may also comprise an ejection port for delivering a jet of air to eject susceptors 25 from the delivery wheel 73 into the aerosol-generating material 3.

The at least one magnet 48 may be a stationary magnet within the wheel 73 which does not rotate, as shown. Alternatively, the at least one magnet may comprise a plurality of movable magnets which rotate with the delivery wheel 73. The at least one magnet 48 may be a permanent magnet or an electromagnet.

The apparatus 40 may further comprise at least one second magnet 49. The at least one magnet 48 may be at least one first magnet 48. The at least one second magnet 49 may be located below at least a part of the aerosol-generating material receiving section 41. The at least one second magnet 49 is configured to attract a ferrous susceptor element 25 towards the aerosol-generating material 3. The at least one second magnet 49 may be in the first operative state at the predefined insertion point to attract a ferrous susceptor element into an aerosol-generating material. The at least one second magnet 49 is located below the predefined insertion point P. the at least one second magnet 49 may be stronger than the at least one first magnet 48.

The at least one second magnet 49 may be a permanent magnet or an electromagnet. The arrangement of the at least one second magnet 49 is similar to the arrangements described above but in relation to the aerosol-generating material receiving section 41 and so a detail description will be omitted herein.

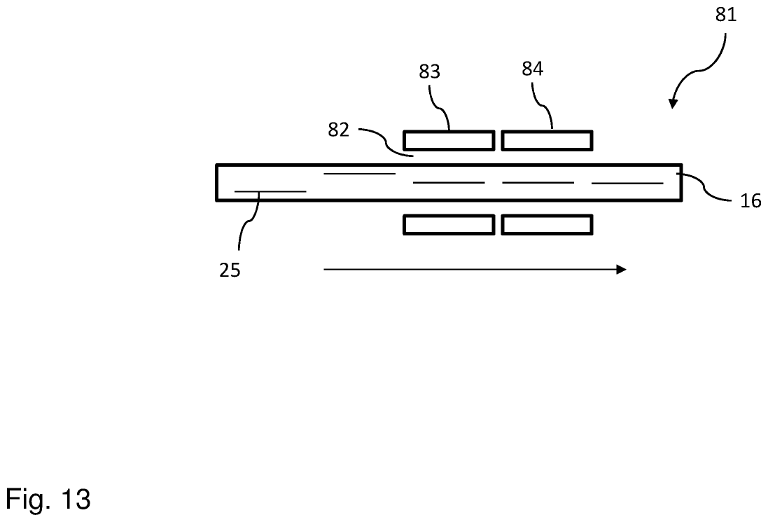

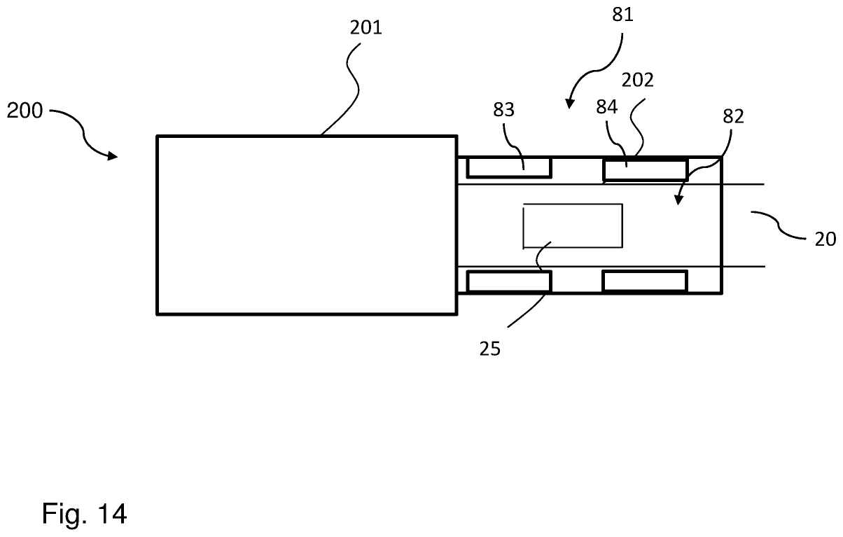

Referring to FIGS. 6 and 13, the apparatus 40 may also comprise a susceptor positioning device 81. However, it will be appreciated that the susceptor positioning device 81 may also be formed within an aerosol provision device 200, as shown in FIG. 14. The description of the susceptor positioning device 81 will be described in reference to both FIG. 13 and FIG. 14.

The susceptor positioning device 81 comprises a rod receiving space 82. The rod receiving space 82 is configured to receive an aerosol-generating material rod 16 comprising a ferrous susceptor element 25. The rod receiving space 82 may be generally defined by a plurality of magnets 83. It will be appreciated that a housing or wall, which defines the rod receiving space 82, may be located between the plurality of magnets 83 and the rod 16. Therefore, the plurality of magnets 83 are arranged around the rod receiving space 82. Preferably, the plurality of magnets 83 are equally spaced around the rod receiving space 82. The magnets 83 may be permanent magnets or electromagnets.

The plurality of magnets 83 are configured to create magnetic fields which are equally strong at the central longitudinal axis of the rod 16. In the present embodiment, the magnetic fields create equal repulsive forces when in the first operative state, i.e. when a susceptor 25 is located between the plurality of magnets to experience the force to a degree that the susceptor can be moved within the rod 16. The plurality of magnets 83 are configured to provide repulsive magnetic forces which align the susceptor 25 with the longitudinal axis of the rod 16, as shown in FIG. 13.

The plurality of magnets 83 are configured such that the force exerted on a ferrous susceptor element 25 by any one magnet 83 may be varied in order to position a ferrous susceptor element 25 in an aerosol-generating material 3 or rod 16 thereof. In some embodiments, the force exerted by any one of the plurality of magnets 83 on a ferrous susceptor element 25 may be varied by moving any one of the plurality of magnets 83. In other embodiments, the plurality of magnets 83 comprises a plurality of electromagnets, and the force exerted by any one of the plurality of electromagnets can be varied by varying the power supplied to any one of the plurality of electromagnets.

The susceptor positioning device 81 may further comprise at least one second magnet 84. The at least one second magnet 84 is spaced longitudinally along the axis of the rod receiving space 82 from the at least one first magnet 83. The arrangement of the at least one second magnet 84, or plurality thereof, is similar to the arrangement of the at least one first magnet 83 and so a detailed description thereof will be omitted herein. The at least one first magnet 83 and the at least one second magnet 84 being configured to position a ferrous susceptor element 25 in the longitudinal direction within an aerosol-generating material rod 16.

As shown in FIG. 6, the rod receiving space 82 may be located on a first path 43 of an aerosol-generating material 3 through the apparatus 40. Alternatively, as shown in FIG. 14, the rod receiving space 82 is an article receiving chamber of an inductive heating aerosol provision device.

In FIG. 14, the components of an embodiment of a non-combustible aerosol provision device 200 are shown in a simplified manner. Particularly, the elements of the non-combustible aerosol provision device 100 are not drawn to scale in FIG. 14. Elements that are not relevant for the understanding of this embodiment have been omitted to simplify FIG. 14.

As shown in FIG. 14, the non-combustible aerosol provision device 200 comprises a non-combustible aerosol-provision device having a housing 201 comprising an area 202 for receiving an article 1.

The area 202 is arranged to receive the article 1. When the article 1 is received into the area 202, the susceptor 25 within the article 1 is located relative to at least one magnetic field generator, i.e. the at least one first and second magnets 83, 84, such that in use the susceptor 25 is located within the magnetic field of the generator. This causes the susceptor 25 to heat up. The aerosol-forming material will release a range of volatile compounds at different temperatures. By controlling the maximum operation temperature of the electrically heated aerosol generating system 100, the selective release of undesirable compounds may be controlled by preventing the release of select volatile compounds.

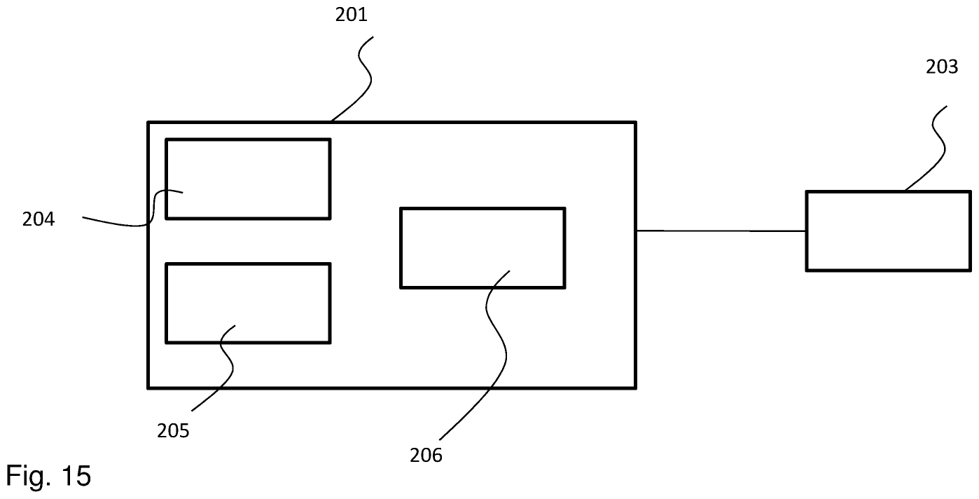

As shown in FIG. 15, within the housing 201 there is an electrical energy supply 204, for example a rechargeable lithium ion battery. A controller 205 is connected to the magnetic field generator, the electrical energy supply 204, and a user interface 206, for example a button or display. The controller 205 controls the power supplied to the magnetic field generator in order to regulate its temperature. Typically the aerosol-forming material is heated to a temperature of between 250 and 450 degrees centigrade.

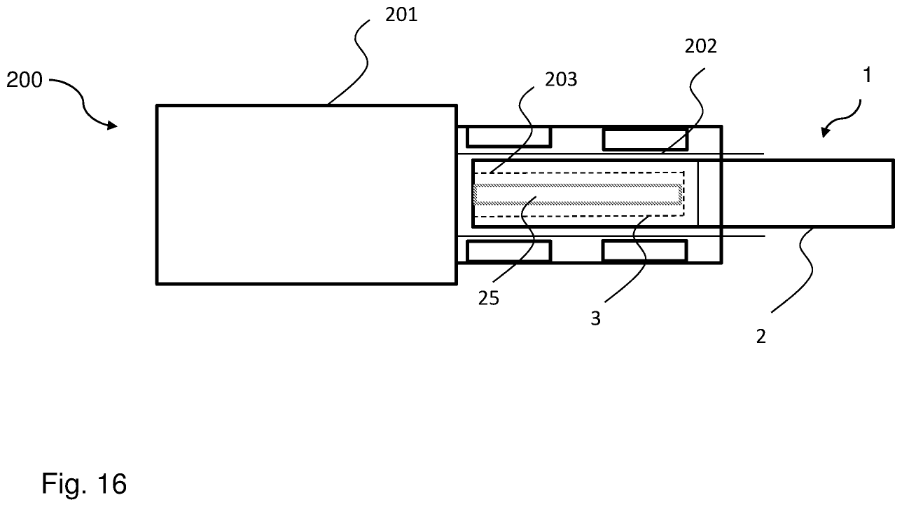

FIG. 16 is a schematic cross-section of a non-combustible aerosol-provision device of the type shown in FIG. 14. The non-combustible aerosol provision device is illustrated in engagement with the aerosol-generating article 1 for consumption of the aerosol-generating article 1 by a user.

The housing 201 of non-combustible aerosol provision device defines an area 202 in the form of a cavity, open at the proximal end (or mouth end), for receiving an aerosol-generating article 1 for consumption.

Referring back to FIG. 6, the apparatus 40 may comprise a gatherer 91. The gatherer 91 is configured to gather the aerosol-generating material 3 substantially transversely around the at least one susceptor 25 to form an aerosol-generating material rod. The gatherer 91 may comprise a funnel 92. The funnel 92 applies substantially transverse forces to the aerosol-generating material 3 as it passes through the funnel 92.

The apparatus 40 may further comprises a first cutter 93. The first cutter 93 is configured to cut the aerosol-generating material rod 16 into aerosol-generating material segments 20.

The apparatus 40 may further comprise a second cutter 94. The second cutter 94 is configured to cut a web 95 of aerosol-generating material 3 longitudinally to produce a plurality of elongate strips. The gatherer 91 may be configured to gather the plurality of elongate strips together to form a rod in which each of the strips extends substantially longitudinally through the rod 16.

In some embodiments, the apparatus 40 may comprises a susceptor cutter 101 configured to cut through a continuous susceptor material 30 and provide the individual susceptors 25 to the hopper 72. Alternatively, the susceptor cutter 101 may be configured to provide the individual susceptors 25 directly to the susceptor transport 52.

The susceptor cutter 101 may comprise a rotary cutting drum 102. The rotary cutting drum 102 may comprise at least one cutting element 103 configured to cut through the susceptor material 30. The susceptor material 30 may be unwound from a bobbin. The susceptor cutter 101 may further comprises a rotary anvil drum 104. The anvil drum 104 transports the susceptor material through the susceptor cutter 101. The anvil drum 104 and cutting drum 103 cooperate to cut through the susceptor material 30.

The speed of the susceptor cutter 101 and/or source of susceptor material may be matched to the flow of the aerosol-generating material 3 along its feed path such that the susceptors 25 are placed in an end-to-end relationship in the flow of aerosol-generating material 3. Therefore, the susceptor 25 may extend the full length of the aerosol-generating material segment 20 formed.

In an alternative embodiment, the speed of the susceptor cutter 101 and/or source of susceptor material may be less than the speed of the flow of aerosol-generating material 3 along its feed path. Therefore, the susceptors 25 may be placed into the flow of aerosol-generating material 3 such that there is a gap between the ends of adjacent susceptors 25. The gap between the ends of adjacent susceptors 25 may be in the range of about 2 mm to about 6 mm, in some embodiments 4 mm. Thus, the susceptor 25 in the resulting aerosol-generating material segment 20 may be spaced from the ends 21, 22 of the aerosol-generating segment 20 by a distance in the range of about 1 mm to about 3 mm, in some embodiments 2 mm, when the first cutter 43 cuts the aerosol-generating material rod 45 in the centre of the gap.

As shown in FIG. 6, the apparatus 40 may further comprise a spindle 106 on which a web 95 of aerosol-generating material 3 is wound to form a bobbin 107. The bobbin 107 of aerosol-generating material 3 is configured to rotate to feed the web 95 of aerosol-generating material 3 from the bobbin 107 through the apparatus 40 along a web feed direction W. In some examples, the apparatus 40 may be arranged to drive the bobbin 107 to rotate. In other examples, the bobbin 107 may be free to rotate, and the web 95 of aerosol-generating material 3 being pulled from the bobbin 107 by a downstream component of the apparatus 40, for example a roller or drive belt (not shown) may cause the bobbin 107 to rotate. In some embodiments, the apparatus may comprise the hopper 72 without the bobbin 107 or susceptor cutter 101. That is, the individual susceptors 25 may be formed in another apparatus (not shown) before being transferred to the hopper 72.

The apparatus 40 may comprise a second cutter 94 is arranged to cut the web 95 of aerosol-generating material 3 longitudinally to produce a plurality of elongate strips 96 of aerosol-generating material 3. The second cutter 111 comprises a first cutting array 112. The second cutter 94 may also comprise a second cutting array 113.

In some embodiments, the second cutter 94 may be configured to crimp the web 95 of aerosol-generating material 3. In an alternative embodiment, the apparatus 40 may comprise a crimping station (not shown). In either case, the apparatus 40 may be configured to crimp the web 94 of aerosol-generating material 3 such that each of the plurality of elongate strips of aerosol-generating material 3 has a crimped section.

In some embodiments, the crimping station (not shown) is upstream of the second cutter 81. In other embodiments, the crimping station is downstream of the second cutter 81 so that the crimping station crimps the plurality of elongate strips of aerosol-generating material 3.

Referring briefly to FIG. 6, the apparatus 40 may further comprise a wrapper 115 configured to wrap the rod of aerosol-generating material 3 in a wrapping material (not shown). The wrapper 115 may wrap a continuous sheet of wrapping material around a circumference of the continuous rod of aerosol-generating material 3, and may apply adhesive to the wrapping material to seal the wrapping material in place around the rod of aerosol-generating material 3.

The method of inserting a ferrous susceptor element in an aerosol-generating material, comprises holding a ferrous susceptor element on a susceptor transporter using magnetic force from at least one magnet, transporting an aerosol-generating material along a first path on an aerosol-generating material transporter, transporting the ferrous susceptor element along a second path on a susceptor transporter, and selectively operating the at least one magnet between a first operative state to exerts a moving force on the ferrous susceptor element, and a second operative state.

The second operative state may comprise moving the at least one magnet into a state in which the at least one magnet is unable to exert a moving force on the ferrous susceptor element.

The method may further comprises moving the at least one magnet is moved from the first operative state to the second operative state at the predefined insertion point to insert the ferrous susceptor element into the aerosol-generating material.

The method of moving between first and second operative states may comprise varying the magnetic force exerted on the ferrous susceptor element at a predefined insertion point where the second path overlaps the first path to cause the ferrous susceptor element to be placed at least on to the aerosol-generating material.

The method may comprise moving the at least one magnet at least a portion of the second path together with the susceptor transporter.

The at least one magnet may be a permanent magnet, and the method may comprise moving the at least one magnet away from the second path at the predefined insertion point to at least reduce the magnetic force from the ferrous susceptor element. Therefore, the ferrous susceptor element drops from the susceptor transporter at least onto the aerosol-generating material transporter.

In other embodiments, the at least one magnet is an electromagnet. The method may therefore comprises reducing the power supplied to the electromagnet at the predefined insertion point to at least reduce the magnetic force from the ferrous susceptor element, so that the ferrous susceptor element drops from the susceptor transporter at least onto the aerosol-generating material on the aerosol-generating material transporter.

The at least one magnet may be held stationary above at least a portion of the second path. The susceptor transporter may be moved relative to the at least one magnet.

When the at least one magnet is a permanent magnet having a downstream end located upstream of the predefined insertion point, the susceptor transporter transports the ferrous susceptor element downstream of and away from the permanent magnet such that the magnet is unable to exert sufficient force to retain the ferrous susceptor element on the susceptor transport so that the ferrous susceptor magnet is dropped at least onto the aerosol-generating material.

When the at least one magnet comprises a plurality of electromagnets arranged linearly above the susceptor transporter along at least a portion of the second path, the power supplied to the plurality of electro magnets is varied to cause the ferrous susceptor element to move along the second path to the predefined insertion point.

In some embodiments, wherein the plurality of electromagnets form act as a linear electric induction motor which forms the susceptor transporter to transport the susceptors along the second path.

The at least one magnet is an at least one first magnet, and the method may further comprise providing at least one second magnet below the aerosol-generating material transporter at the predefined insertion point configured to apply a force on a susceptor to move the susceptor from the susceptor transporter to the aerosol-generating material on the aerosol-generating material transporter.

The method may comprise applying a stronger magnetic force to the susceptor with the at least one second magnet than with the at least one first magnet to pull the susceptor from the susceptor transporter to the aerosol-generating material transporter.

A method of positioning a susceptor within a rod of aerosol-generating material comprises placing a rod of aerosol-generating material comprising a susceptor between at least two magnets, applying a magnetic field to the susceptor move the susceptor to a predefined position in the rod of aerosol-generating material using magnetic forces.

When the at least two magnets are electromagnets, moving the susceptor comprises applying an electromagnetic filed to the susceptor to position it correctly relative to the rod of aerosol-generating material.

The method of manufacturing an aerosol-generating composition for use in a non-combustible aerosol provision device, wherein the composition comprises aerosol-generating material and one or more magnetic elements, comprises combining the aerosol-generating material with the one or more magnetic elements, applying a magnetic force to the one or more magnetic elements, and manipulating a position of the elements with respect to the aerosol-generating material using the applied magnetic force. The method may further comprise wrapping the aerosol-generating composition with a wrapper.

The method of separating one or more magnetic elements from aerosol-generating material comprises applying a magnetic force to the one or more magnetic elements to magnetically attract or repel the one or more elements such that the one or more elements become separated from the aerosol-generating material.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An apparatus for positioning a ferrous susceptor relative to an aerosol-generating material, the apparatus comprising:
an aerosol-generating material receiving section configured to receive an aerosol-generating material;
at least one magnet, wherein the at least one magnet is configured to position a ferrous susceptor element in a first predetermined position relative to an aerosol-generating material received in the aerosol-generating material receiving section;
wherein the at least one magnet has a first operative state in which the at least one magnet is operative to exert a moving force on a ferrous susceptor element, and a second operative state;
wherein the at least one magnet can be selectively moved between the first operative state and the second operative state.

2. The apparatus according to claim 2, wherein in the second operative state, the at least one magnet is operative to exert a moving force on a ferrous susceptor element that is opposite to the moving force applied in the first operative state.

3. The apparatus according to claim 1, wherein the second operative state that at least one magnet is non-operative and unable to exert a moving force on a ferrous susceptor element.

4. The apparatus according to any one of the preceding claims, wherein the aerosol-generating material receiving section comprises an aerosol-generating material transporter configured to transport an aerosol-generating material along a first path.

5. The apparatus according to claim 4, further comprising a susceptor transporter configured to transport a ferrous susceptor element along a second path.

6. The apparatus according to claim 5, wherein the at least one magnet is configured to be selectively operated along the second path to insert a ferrous susceptor element into an aerosol-generating material transported along the first path at a predefined insertion point where the first and second paths overlap.

7. The apparatus according to claim 5 or claim 6, further comprising an overlapping section of the first and second paths, the at least one magnet being selectively moved from one state to the other to insert a ferrous susceptor element into an aerosol-generating material.

8. The apparatus according to claim 7, wherein at the overlapping section of the first and second paths, the susceptor transporter is located vertically above the aerosol-generating material transporter.

9. The apparatus according to claim 8, wherein the at least one magnet is located above at least a portion of the susceptor transporter.

10. The apparatus according to claim 9, wherein the at least one magnet is located above the overlapping portion of the second path of the susceptor transporter.

11. The apparatus according to claim 10, wherein the at least one magnet is located above the predefined insertion point, and configured to be selectively moved from one state to the other to insert a ferrous susceptor element into an aerosol-generating material.

12. The apparatus according to claim 11, wherein the at least one magnet is moveable along a path which overlaps the overlapping portion of the first and second paths.

13. The apparatus according to claim 12, wherein the at least one magnet is selectively moved between the first operative state and the second operative state, when the at least one magnet is located above the predefined insertion point.

14. The apparatus according to claim 13, wherein the at least one magnet is at least one electromagnet powered by a power source, the power source being configured to power the electromagnet in the first operative state and to switch the electromagnet into the second operative state at the predefined insertion point.

15. The apparatus according to claim 13, wherein the at least one magnet is moveable in a direction away from the second path to move the at least one magnet from the first operative state to the second operative state, when the at least one magnet is located above the predefined insertion point.

16. The apparatus according to any one of claim 1 to claim 11, wherein the at least one magnet is stationary.

17. The apparatus according to claim 16, wherein the at least one magnet comprises a downstream end which is located upstream of the predefined insertion point such that when a ferrous susceptor element passes the at least one magnet, the at least one magnet is in a second operative state in which it is unable to attract a ferrous susceptor element.

18. The apparatus according to claim 16, wherein the at least one magnet comprises at least one electromagnet, the at least one electromagnet being selectively operated to be in a first operative state upstream of the predefined insertion point, and in a second operative state at the predefined insertion point.

19. The apparatus according to claim 17, comprising a plurality of electromagnets configured to act as a linear induction motor.

20. The apparatus according to claim 19, wherein the plurality of electromagnets form the susceptor transporter.

21. The apparatus according to any one of claim 6 to claim 20, further comprising at least one second magnet, the at least one second magnet being located below the aerosol-generating transporter, and being configured to be in the first operative state at the predefined insertion point to attract a ferrous susceptor element into an aerosol-generating material.

22. The apparatus according to claim 21, wherein the at least one second magnet is located below the predefined insertion point.

23. The apparatus according to claim 21 or claim 22, wherein the at least one second magnet is stronger than the at least one magnet.

24. The apparatus according to any one of claim 1 to claim 19 or claim 21 to claim 23, wherein the susceptor transporter is a conveyor belt.

25. The apparatus according to any one of claim 1 to claim 19 or claim 21 to claim 23, wherein the susceptor transporter is a rotary wheel.

26. The apparatus according to any one of the preceding claims, wherein the aerosol-generating material receiving section comprises a susceptor positioning device comprising a rod receiving space configured to receive an aerosol-generating material rod comprising a ferrous susceptor element.

27. The apparatus according to claim 26, wherein the rod receiving section is defined by a plurality of magnets.

28. The apparatus according to claim 27, wherein the plurality of magnets are equally spaced around the aerosol-generating material receiving section.

29. The apparatus according to claim 27 or claim 28, wherein the plurality of magnets are configured to create equal repulsive forces when in the first operative state to align a ferrous susceptor element with a central axis of plurality of magnets.

30. The apparatus according to claim 27 or claim 28, wherein the plurality of magnets are configured such that the force exerted on a ferrous susceptor element by any one magnet may be varied in order to position a ferrous susceptor element in an aerosol-generating material.

31. The apparatus according to claim 30, wherein the force exerted by any one of the plurality of magnets on a ferrous susceptor may be varied by moving any one of the plurality of magnets.

32. The apparatus according to claim 30 or claim 31, wherein the plurality of magnets comprises a plurality of electromagnets, and the force exerted by any one of the plurality of electromagnets can be varied by varying the power supplied to any one of the plurality of electromagnets.

33. The apparatus according to any one of claim 26 to claim 32, further comprising at least one second magnet, wherein the at least one second magnet is spaced longitudinally along the axis of the rod receiving space from the at least one magnet, the at least one first magnet and the at least one second magnet being configured to position a ferrous susceptor element in the longitudinal direction within an aerosol-generating material rod.

34. The apparatus according to any one of claim 26 to claim 33, wherein the rod receiving space is located on a first path of an aerosol-generating material through the apparatus.

35. The apparatus according to any one of claim 26 to claim 33, wherein the rod receiving space is an article receiving chamber of an inductive heating aerosol provision device.

36. A method of inserting a ferrous susceptor element in an aerosol-generating material, the method comprising:
holding a ferrous susceptor element on a susceptor transporter using magnetic force from at least one magnet;
transporting an aerosol-generating material along a first path on an aerosol-generating material transporter;
transporting the ferrous susceptor element along a second path on a susceptor transporter; and
selectively operating the at least one magnet between a first operative state to exerts a moving force on the ferrous susceptor element, and a second operative state in which the at least one magnet is unable to exert a moving force on the ferrous susceptor element.

37. The method according to claim 36, wherein the at least one magnet is moved from the first operative state to the second operative state at the predefined insertion point to insert the ferrous susceptor element into the aerosol-generating material.

38. The method according to claim 37, further comprising varying the magnetic force exerted on the ferrous susceptor element at a predefined insertion point where the second path overlaps the first path to cause the ferrous susceptor element to be placed at least on to the aerosol-generating material.

39. The method according to claim 37 or claim 38, wherein the at least one magnet is moved along at least a portion of the second path together with the susceptor transporter.

40. The method according to claim 39, wherein the at least one magnet is a permanent magnet, and wherein the at least one magnet is moved away from the second path at the predefined insertion point to at least reduce the magnetic force from the ferrous susceptor element, so that the ferrous susceptor element drops from the susceptor transporter at least onto the aerosol-generating material transporter.

41. The method according to claim 39, wherein the at least one magnet is an electromagnet, and wherein the power supplied to the electromagnet is reduced at the predefined insertion point to at least reduce the magnetic force from the ferrous susceptor element, so that the ferrous susceptor element drops from the susceptor transporter at least onto the aerosol-generating material on the aerosol-generating material transporter.

42. The method according to claim 37 or claim 38, wherein the at least one magnet is stationary above at least a portion of the second path, and the susceptor transporter is moved relative to the at least one magnet.

43. The method according to claim 42, wherein the at least one magnet is a permanent magnet having a downstream end located upstream of the predefined insertion point, and wherein the susceptor transporter transports the ferrous susceptor element downstream of and away from the permanent magnet such that the magnet is unable to exert sufficient force to retain the ferrous susceptor element on the susceptor transport so that the ferrous susceptor magnet is dropped at least onto the aerosol-generating material.

44. The method according to claim 42, wherein the at least one magnet comprises a plurality of electromagnets arranged linearly above the susceptor transporter along at least a portion of the second path, wherein the power supplied to the plurality of electro magnets is varied to cause the ferrous susceptor element to move along the second path to the predefined insertion point.

45. The method according to claim 44, wherein the plurality of electromagnets act as a linear electric induction motor which forms the susceptor transporter.

46. The method according to any one of claim 37 to claim 45, wherein the at least one magnet is an at least one first magnet, and further comprising providing at least one second magnet below the aerosol-generating material transporter at the predefined insertion point configured to apply a force on a susceptor to move the susceptor from the susceptor transporter to the aerosol-generating material on the aerosol-generating material transporter.

47. The method according to claim 46, comprising applying a stronger magnetic force to the susceptor with the at least one second magnet than with the at least one first magnet.

48. A method of positioning a susceptor within a rod of aerosol-generating material; the method comprising:
placing a rod of aerosol-generating material comprising a susceptor between at least two magnets;
applying a magnetic field to the susceptor move the susceptor to a predefined position in the rod of aerosol-generating material using magnetic forces.

49. The method according to claim 48, wherein the at least two magnets are electromagnets, and moving the susceptor comprises applying an electromagnetic filed to the susceptor to position it correctly relative to the rod of aerosol-generating material.

50. A method of manufacturing an aerosol-generating composition for use in a non-combustible aerosol provision device, the composition comprising aerosol-generating material and one or more magnetic elements, the method comprising:
combining the aerosol-generating material with the one or more magnetic elements;
applying a magnetic force to the one or more magnetic elements; and
manipulating a position of the elements with respect to the aerosol-generating material using the applied magnetic force.

51. The method according to claim 50, further comprising wrapping the aerosol-generating composition with a wrapper.

52. A method of separating one or more magnetic elements from aerosol-generating material, the method comprising:
applying a magnetic force to the one or more magnetic elements to magnetically attract or repel the one or more elements such that the one or more elements become separated from the aerosol-generating material.
